(19) United States
(12) Patent Application Publication
(10) Pub. No.: US 2025/0035459 A1
(43) Pub. Date: Jan. 30, 2025

(54) Drone-Based Augmented Reality Parking Assistance

(71) Applicant: Mercedes-Benz Group AG, Stuttgart (DE)

(72) Inventors: Kavita Saney, Fremont, CA (US); Kevin Gee, Union City, CA (US)

(21) Appl. No.: 18/360,415

(22) Filed: Jul. 27, 2023

(51) Int. Cl. G01C 21/36

(52) U.S. Cl. CPC G01C 21/365; G01C 21/3685; B64U 10/00; B64U 2101/00

(57) ABSTRACT

Methods, computing systems, and technology for locating available parking spaces are presented. For example, a computing system may be configured to access data indicative of an available parking space identified by a drone. The computing system may be configured to determine, based on the data indicative of the available parking space identified by the drone, a location of the available parking space. The computing system may be configured to determine a route, for a vehicle, to the location of the available parking space. The computing system may be configured to generate content comprising information for navigating to the location of the available parking space. The computing system may be configured to output one or more signals to initiate a display of the content for a user via a user interface of a wearable display device, the content comprising the information for navigating to the location of the available parking space.

### FIELD

The present disclosure relates generally to locating available parking spots for a vehicle. More particularly, the present disclosure relates to augmenting the visibility of a vehicle operator to locate available parking spots in a parking area by leveraging an augmented reality user interface and a drone.

### BACKGROUND

A vehicle may require parking or other storage accommodations when reaching a destination. The destination may include available parking spots to safely and securely store the vehicle such that the vehicle does not impede traffic or pedestrians.

### SUMMARY

Aspects and advantages of implementations of the present disclosure will be set forth in part in the following description, or may be learned from the description, or may be learned through practice of the implementations.

One example aspect of the present disclosure is directed to a computing system of a vehicle. The computing system includes a control circuit configured to access data indicative of an available parking space identified by a drone. The control circuit is configured to determine, based on the data indicative of the available parking space identified by the drone, a location of the available parking space. The control circuit is configured to determine a route, for a vehicle, to the location of the available parking space. The control circuit is configured to based on the route to the location of the available parking space, generate content comprising information for navigating to the location of the available parking space. The control circuit is configured to output one or more signals to initiate a display of the content for a user via a user interface of a wearable display device, the content comprising the information for navigating to the location of the available parking space.

In an embodiment, the control circuit is configured to determine that the vehicle is approaching, or has entered, a parking area. In an embodiment, the control circuit is configured to output one or more signals to initiate the drone to take-off from onboard the vehicle to search the parking area for one or more available parking spaces.

In an embodiment, the content includes augmented reality content including a user interface element, the user interface element indicating the location of the available parking space.

In an embodiment, the wearable display device is a head-worn computing device. In an embodiment, the user interface element indicating the location of the available parking space is visible in a field-of-view that includes the available parking space.

In an embodiment, the data indicative of the available parking space identified by the drone includes location data provided by the drone.

In an embodiment, the location data is indicative of a location of the drone.

In an embodiment, to determine the location of the available parking space, the control circuit is configured to determine the location of the available parking space based on the location of the drone.

In an embodiment, to determine the route, for the vehicle, to the location of the available parking space the control circuit is configured to determine a route to the location of the drone.

In an embodiment, the drone is positioned above the available parking space.

In an embodiment, the control circuit is further configured to access map data associated with a parking area comprising the available space. In an embodiment, to determine the route, for the vehicle, to the location of the available parking space, the control circuit is configured to determine the route based also on the map data associated with the parking area.

In an embodiment, the drone is included within a plurality of drones associated with the parking area.

In an embodiment, the control circuit is configured to determine that the available parking space is appropriate for the vehicle based on at least one of: (i) a type of the available parking space; (ii) a size of the available parking space; (iii) an orientation of the available parking space; (iv) a restriction associated with the available parking space; or (v) a preference of the user.

One example aspect of the present disclosure is directed to a computer-implemented method. The computer-implemented method includes accessing data indicative of an available parking space identified by a drone. The computer-implemented method includes determining, based on the data indicative of the available parking space identified by the drone, a location of the available parking space. The computer-implemented method includes determining a route, for a vehicle, to the location of the available parking space. The computer-implemented method includes based on the route to the location of the available parking space, generating content comprising information for navigating to the location of the available parking space. The computer-implemented method includes outputting one or more signals to initiate a display of the content for a user via a user interface of a wearable display device, the content comprising the information for navigating to the location of the available parking space.

In an embodiment, the computer-implemented method includes determining that the vehicle is approaching, or has entered, a parking area. In an embodiment, the computer-implemented method includes outputting one or more signals to initiate the drone to take-off from onboard the vehicle to search the parking area for one or more available parking spaces.

In an embodiment, the content includes augmented reality content including a user interface element, the user interface element indicating the location of the available parking space.

In an embodiment, the wearable display device is a head-worn computing device. In an embodiment, the user interface element indicating the location of the available parking space is visible in a field-of-view that comprises the available parking space.

In an embodiment, the data indicative of the available parking space identified by the drone comprises location data provided by the drone.

In an embodiment, the location data is indicative of a location of the drone.

In an embodiment, determining the location of the available parking space, includes determining the location of the available parking space based on the location of the drone.

One example aspect of the present disclosure is directed to one or more non-transitory computer-readable media that store instructions that are executable by a control circuit to: access data indicative of an available parking space identified by a drone; determine, based on the data indicative of the available parking space identified by the drone, a location of the available parking space; determine a route, for a vehicle, to the location of the available parking space; based on the route to the location of the available parking space, generating content comprising information for navigating to the location of the available parking space; and output one or more signals to initiate a display of the content for a user via a user interface of a wearable display device, the content comprising the information for navigating to the location of the available parking space.

Other example aspects of the present disclosure are directed to other systems, methods, vehicles, apparatuses, tangible non-transitory computer-readable media, and devices for the technology described herein.

These and other features, aspects, and advantages of various implementations will become better understood with reference to the following description and appended claims. The accompanying drawings, which are incorporated in and constitute a part of this specification, illustrate implementations of the present disclosure and, together with the description, serve to explain the related principles.

### BRIEF DESCRIPTION OF THE DRAWINGS

Detailed discussion of implementations directed to one of ordinary skill in the art are set forth in the specification, which makes reference to the appended figures, in which:

FIG. 1 illustrates an example computing ecosystem according to an embodiment hereof.

FIGS. 2A-D illustrate diagrams of an example computing architecture for an onboard computing system of a vehicle according to an embodiment hereof.

FIG. 3 illustrates an example vehicle interior with an example display according to an embodiment hereof.

FIG. 4 illustrates a diagram of an example computing platform that is remote from a vehicle according to an embodiment hereof.

FIG. 5 illustrates a diagram of an example user device according to an embodiment hereof.

FIG. 6 illustrates an example vehicle and drone operation according to an embodiment hereof.

FIG. 7 illustrates a parking area according to an embodiment hereof.

FIGS. 8A-B illustrates example user interfaces according to embodiments hereof.

FIG. 9 illustrates an example augmented user interface according to an embodiment hereof.

FIG. 10 illustrates an example dataflow pipeline according to an embodiment hereof.

FIG. 11 illustrates a flowchart diagram of an example method according to an embodiment hereof.

FIG. 12 illustrates a diagram of an example computing ecosystem with computing components according to an embodiment hereof.

### DETAILED DESCRIPTION

An aspect of the present disclosure relates to systems and methods for locating parking spaces. For instance, a vehicle may travel from one destination to another and require parking to safely and securely store the vehicle at the destination. The destination may include a parking area that provides designated parking spaces for the vehicle. However, in certain circumstances, the parking area may become crowded and locating available parking spaces among several other occupied parking spaces may be difficult and time consuming.

To address this problem, the technology of the present disclosure allows the vehicle to utilize a drone to detect available parking spaces and generate navigational content to present to an operator of the vehicle. For instance, the drone may be docked on a surface or exterior of the vehicle and upon approaching the destination, the vehicle may deploy the drone to survey the parking area to locate available parking spaces. Once the drone has located an available parking space, the drone may hover above the available parking space to prevent other vehicles from occupying the parking space prior to the arrival of the vehicle. The drone may share directional indicators with the vehicle such as the location of the parking spot, directions to reach the parking etc. The vehicle may receive the directional indicators and generate navigation content to present to the vehicle operator or a passenger. This may include displaying the navigational content via an augmented reality (AR) interface on wearable smart glasses or a head unit display device. Once the vehicle reaches the location of the available parking space located by the drone, the drone may dock on the vehicle.

According to example embodiments of the present disclosure, a machine-learned model may locate parking spaces based on user input data, such as user preferences, to locate parking spaces satisfactory to the vehicle operator. A software application (e.g., on a user device, on a vehicle computing system, etc.) can provide the operator of the vehicle with generative tools to create and modify different user preference options. For instance, the application can provide passengers of the vehicle with options to choose parking space preferences, such as handicap parking, minimum parking space dimensions, maximum distance from destination, etc. The user preferences may be used as input into the machine-learned model to locate parking spaces which satisfy the user preferences of the passenger.

The technology of the present disclosure also improves the energy usage and onboard computing technology of the vehicle. For instance, the vehicle's onboard computing system may obtain destination data, via user input, indicative of a future destination of the vehicle. The vehicle computing system may determine, based on the destination data, that an available parking space will be required once the vehicle reaches the destination. The vehicle computing system may determine that the vehicle is approaching or entering the parking area and deploy a drone to locate an available parking space prior to the arrival of the vehicle. The drone may locate an available space and transmit, via one or more networks, location data indicating the location of the drone (e.g., the available space) to the vehicle computing system. The vehicle computing system may output, to a head-worn user device (e.g., AR glasses) paired to the vehicle, a signal indicating the location of the available space and directional indicators which indicate a path to the location of the available space. Accordingly, the vehicle computing system may avoid wasting its own computing resources to locate an available parking space and providing navigation to the vehicle operator. In this way, the vehicle computing system can more efficiently utilize its computing resources, as well as reduce energy otherwise wasted traversing a parking area in search of available spaces.

The technology of the present disclosure may include the collection of data associated with a user in the event that the user expressly authorizes such collection. Such authorization may be provided by the user via explicit user input to a user interface in response to a prompt that expressly requests such authorization. Collected data may be anonymized, pseudonymized, encrypted, noised, securely stored, or otherwise protected. A user may opt out of such data collection at any time.

Reference now will be made in detail to embodiments, one or more examples of which are illustrated in the drawings. Each example is provided by way of explanation of the embodiments, not limitation of the present disclosure. In fact, it will be apparent to those skilled in the art that various modifications and variations may be made to the embodiments without departing from the scope or spirit of the present disclosure. For instance, features illustrated or described as part of one embodiment may be used with another embodiment to yield a still further embodiment. Thus, it is intended that aspects of the present disclosure cover such modifications and variations.

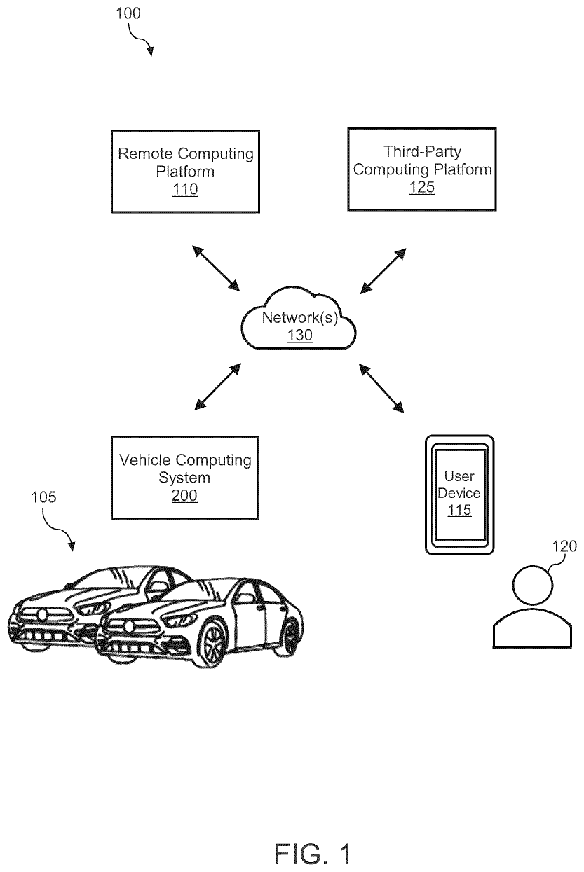

FIG. 1 illustrates an example computing ecosystem 100 according to an embodiment hereof. The ecosystem 100 may include a vehicle 105, a remote computing platform 110 (also referred to herein as computing platform 110), and a user device 115 associated with a user 120. The user 120 may be a driver of the vehicle. In some implementations, the user 120 may be a passenger of the vehicle. In some implementations, the computing ecosystem 100 may include a third party (3P) computing platform 125, as further described herein. The vehicle 105 may include a vehicle computing system 200 located onboard the vehicle 105. The computing platform 110, the user device 115, the third party computing platform 125, and/or the vehicle computing system 200 may be configured to communicate with one another via one or more networks 130.

The systems/devices of ecosystem 100 may communicate using one or more application programming interfaces (APIs). This may include external facing APIs to communicate data from one system/device to another. The external facing APIs may allow the systems/devices to establish secure communication channels via secure access channels over the networks 130 through any number of methods, such as web-based forms, programmatic access via RESTful APIs, Simple Object Access Protocol (SOAP), remote procedure call (RPC), scripting access, etc.

The computing platform 110 may include a computing system that is remote from the vehicle 105. In an embodiment, the computing platform 110 may include a cloud-based server system. The computing platform 110 may be associated with (e.g., operated by) an entity. For example, the remote computing platform 110 may be associated with an OEM that is responsible for the make and model of the vehicle 105. In another example, the remote computing platform 110 may be associated with a service entity contracted by the OEM to operate a cloud-based server system that provides computing services to the vehicle 105.

The computing platform 110 may include one or more back-end services for supporting the vehicle 105. The services may include, for example, tele-assist services, navigation/routing services, performance monitoring services, etc. The computing platform 110 may host or otherwise include one or more APIs for communicating data to/from a computing system 130 of the vehicle 105 or the user device 115. The computing platform 110 may include one or more inter-service APIs for communication among its microservices. In some implementations, the computing platform may include one or more RPCs for communication with the user device 115.

The computing platform 110 may include one or more computing devices. For instance, the computing platform 110 may include a control circuit and a non-transitory computer-readable medium (e.g., memory). The control circuit of the computing platform 110 may be configured to perform the various operations and functions described herein. Further description of the computing hardware and components of computing platform 110 is provided herein with reference to other figures.

The user device 115 may include a computing device owned or otherwise accessible to the user 120. For instance, the user device 115 may include a phone, laptop, tablet, wearable device (e.g., smart watch, smart glasses, headphones), personal digital assistant, gaming system, personal desktop devices, other hand-held devices, or other types of mobile or non-mobile user devices. As further described herein, the user device 115 may include one or more input components such as buttons, a touch screen, a joystick or other cursor control, a stylus, a microphone, a camera or other imaging device, a motion sensor, etc. The user device 115 may include one or more output components such as a display device (e.g., display screen), a speaker, etc. For a wearable device such as a pair of smart-glasses, the display device may be formed/integrated into the lens of the glasses or the display device may have a form-figure in the shape of the lens.

In an embodiment, the user device 115 may include a component such as, for example, a touchscreen, configured to perform input and output functionality to receive user input and present information for the user 120. The user device 115 may execute one or more instructions to run an instance of a software application and present user interfaces associated therewith, as further described herein. In an embodiment, the launch of a software application may initiate a user-network session with the computing platform 110.

The third-party computing platform 125 may include a computing system that is remote from the vehicle 105, remote computing platform 110, and user device 115. In an embodiment, the third-party computing platform 125 may include a cloud-based server system. The term “third-party entity” may be used to refer to an entity that is different than the entity associated with the remote computing platform 110. For example, as described herein, the remote computing platform 110 may be associated with an OEM that is responsible for the make and model of the vehicle 105. The third-party computing platform 125 may be associated with a supplier of the OEM, a maintenance provider, a mapping service provider, an emergency provider, or other types of entities. In another example, the third-party computing platform 125 may be associated with an entity that owns, operates, manages, etc. a software application that is available to or downloaded on the vehicle computing system 200.

The third-party computing platform 125 may include one or more back-end services provided by a third-party entity. The third-party computing platform 125 may provide services that are accessible by the other systems and devices of the ecosystem 100. The services may include, for example, mapping services, routing services, search engine functionality, maintenance services, entertainment services (e.g., music, video, images, gaming, graphics), emergency services (e.g., roadside assistance, 911 support), or other types of services. The third-party computing platform 125 may host or otherwise include one or more APIs for communicating data to/from the third-party computing system 125 to other systems/devices of the ecosystem 100.

The networks 130 may be any type of network or combination of networks that allows for communication between devices. In some implementations, the networks 130 may include one or more of a local area network, wide area network, the Internet, secure network, cellular network, mesh network, peer-to-peer communication link or some combination thereof and may include any number of wired or wireless links. Communication over the networks 130 may be accomplished, for instance, via a network interface using any type of protocol, protection scheme, encoding, format, packaging, etc. In an embodiment, communication between the vehicle computing system 200 and the user device 115 may be facilitated by near field or short range communication techniques (e.g., Bluetooth low energy protocol, radio frequency signaling, NFC protocol).

The vehicle 105 may be a vehicle that is operable by the user 120. In an embodiment, the vehicle 105 may be an automobile or another type of ground-based vehicle that is manually driven by the user 120. For example, the vehicle 105 may be a Mercedes-Benz® car or van. In some implementations, the vehicle 105 may be an aerial vehicle (e.g., a personal airplane) or a water-based vehicle (e.g., a boat). The vehicle 105 may include operator-assistance functionality such as cruise control, advanced driver assistance systems, etc. In some implementations, the vehicle 105 may be a fully or semi-autonomous vehicle.

The vehicle 105 may include a powertrain and one or more power sources. The powertrain may include a motor (e.g., an internal combustion engine, electric motor, or hybrid thereof), e-motor (e.g., electric motor), transmission (e.g., automatic, manual, continuously variable), driveshaft, axles, differential, e-components, gear, etc. The power sources may include one or more types of power sources. For example, the vehicle 105 may be a fully electric vehicle (EV) that is capable of operating a powertrain of the vehicle 105 (e.g., for propulsion) and the vehicle's onboard functions using electric batteries. In an embodiment, the vehicle 105 may use combustible fuel. In an embodiment, the vehicle 105 may include hybrid power sources such as, for example, a combination of combustible fuel and electricity.

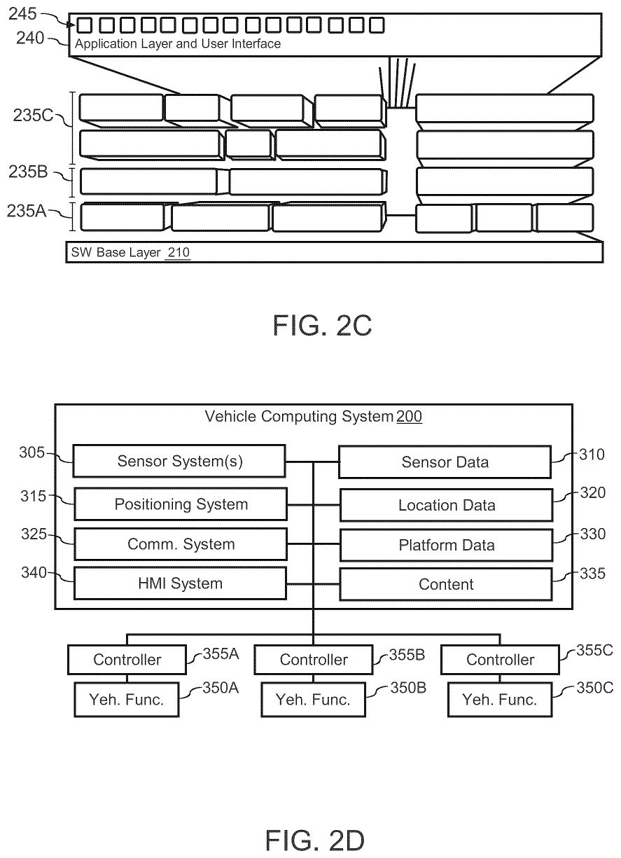

The vehicle 105 may include a vehicle interior. The vehicle interior may include the area inside of the body of the vehicle 105 including, for example, a cabin for users of the vehicle 105. The interior of the vehicle 105 may include seats for the users, a steering mechanism, accelerator interface, braking interface, etc. The interior of the vehicle 105 may include a display device such as a display screen associated with an infotainment system, as further described with respect to FIG. 3.

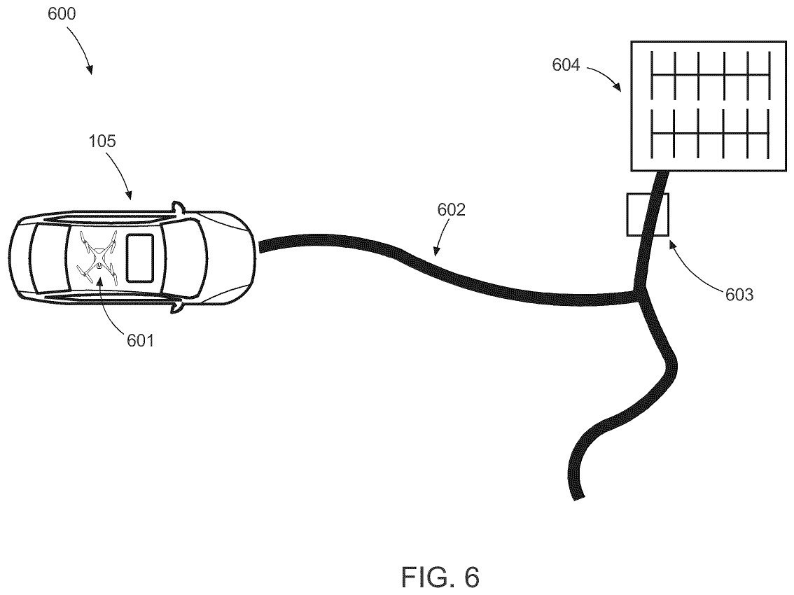

The vehicle 105 may include a vehicle exterior. The vehicle exterior may include the outer surface of the vehicle 105. The vehicle exterior may include one or more lighting elements (e.g., headlights, brake lights, accent lights). The vehicle 105 may include one or more doors for accessing the vehicle interior by, for example, manipulating a door handle of the vehicle exterior. The vehicle 105 may include one or more windows, including a windshield, door windows, passenger windows, rear windows, sunroof, etc. The vehicle 105 may include a docking surface for accommodating one or more autonomous drones. For instance, the vehicle 105 may be associated with a drone controllable by the vehicle computing system 200 as further described with respect to FIG. 6.

The systems and components of the vehicle 105 may be configured to communicate via a communication channel. The communication channel may include one or more data buses (e.g., controller area network (CAN)), on-board diagnostics connector (e.g., OBD-II), or a combination of wired or wireless communication links. The onboard systems may send or receive data, messages, signals, etc. amongst one another via the communication channel.

In an embodiment, the communication channel may include a direct connection, such as a connection provided via a dedicated wired communication interface, such as a RS-232 interface, a universal serial bus (USB) interface, or via a local computer bus, such as a peripheral component interconnect (PCI) bus. In an embodiment, the communication channel may be provided via a network. The network may be any type or form of network, such as a personal area network (PAN), a local-area network (LAN), Intranet, a metropolitan area network (MAN), a wide area network (WAN), or the Internet. The network may utilize different techniques and layers or stacks of protocols, including, e.g., the Ethernet protocol, the internet protocol suite (TCP/IP), the ATM (Asynchronous Transfer Mode) technique, the SONET (Synchronous Optical Networking) protocol, or the SDH (Synchronous Digital Hierarchy) protocol.

In an embodiment, the systems/devices of the vehicle 105 may communicate via an intermediate storage device, or more generally an intermediate non-transitory computer-readable medium. For example, the non-transitory computer-readable medium 140, which may be external to the computing system 130, may act as an external buffer or repository for storing information. In such an example, the computing system 130 may retrieve or otherwise receive the information from the non-transitory computer-readable medium 140.

Certain routine and conventional components of vehicle 105 (e.g., an engine) are not illustrated and/or discussed herein for the purpose of brevity. One of ordinary skill in the art will understand the operation of conventional vehicle components in vehicle 105.

The vehicle 105 may include a vehicle computing system 200. As described herein, the vehicle computing system 200 is onboard the vehicle 105. For example, the computing devices and components of the vehicle computing system 200 may be housed, located, or otherwise included on or within the vehicle 105. The vehicle computing system 200 may be configured to execute the computing functions and operations of the vehicle 105.

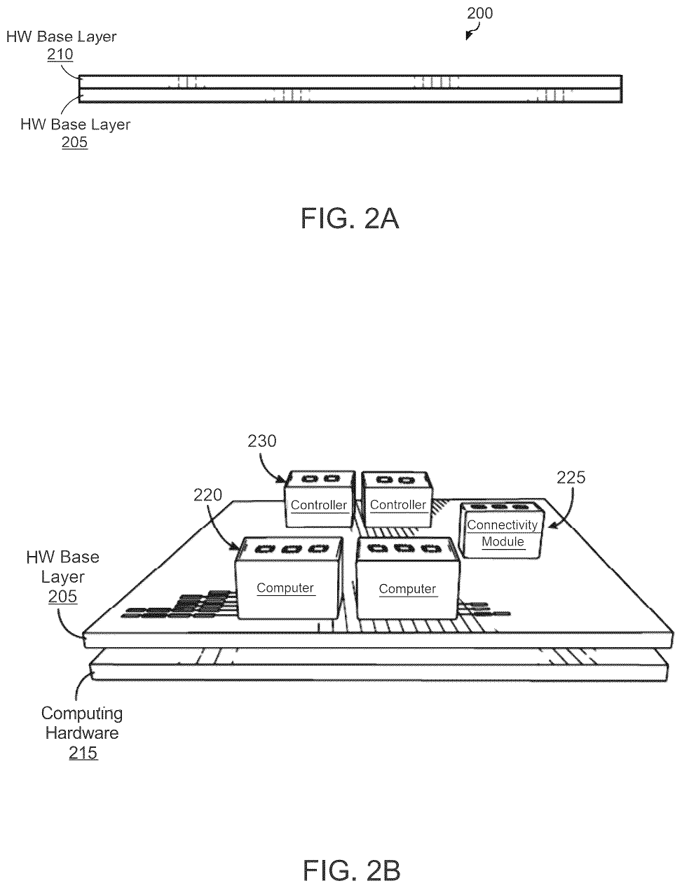

FIG. 2A illustrates an overview of an operating system of the vehicle computing system 105. The operating system may be a layered operating system. The vehicle computing system 200 may include a hardware layer 205 and a software layer 210. The hardware and software layers 205, 210 may include sub-layers. In some implementations, the operating system of the vehicle computing system 200 may include other layers (e.g., above, below, or in between those shown in FIG. 2A). In an example, the hardware layer 205 and the software layer 210 can be standardized base layers of the vehicle's operating system.

FIG. 2B illustrates a diagram of the hardware layer 205 of the vehicle computing system 200. In the layered operating system of the vehicle computing system 200, the hardware layer 205 can reside between the physical computing hardware 215 onboard the vehicle 105 and the software (e.g., of software layer 210) that runs onboard the vehicle 105.

The hardware layer 205 may be an abstraction layer including computing code that allows for communication between the software and the computing hardware 215 in the vehicle computing system 200. For example, the hardware layer 205 may include interfaces and calls that allow the vehicle computing system 200 to generate a hardware-dependent instruction to the computing hardware 215 (e.g., processors, memories, etc.) of the vehicle 105.

The hardware layer 205 may be configured to help coordinate the hardware resources. The architecture of the hardware layer 205 may be serviced oriented. The services may help provide the computing capabilities of the vehicle computing system 105. For instance, the hardware layer 205 may include the domain computers 220 of the vehicle 105, which may host various functionality of the vehicle 105 such as the vehicle's intelligent functionality. The specification of each domain computer may be tailored to the functions and the performance requirements where the services are abstracted to the domain computers. By way of example, this permits certain processing resources (e.g., graphical processing units) to support the functionality of a central in-vehicle infotainment computer for rendering graphics across one or more display devices for navigation, games, etc. or to support an intelligent automated driving computer to achieve certain industry assurances.

The hardware layer 205 may be configured to include a connectivity module 225 for the vehicle computing system 200. The connectivity module may include code/instructions for interfacing with the communications hardware of the vehicle 105. This can include, for example, interfacing with a communications controller, receiver, transceiver, transmitter, port, conductors, or other hardware for communicating data/information. The connectivity module 225 may allow the vehicle computing system 200 to communicate with other computing systems that are remote from the vehicle 105 including, for example, remote computing platform 110 (e.g., an OEM cloud platform).

The architecture design of the hardware layer 205 may be configured for interfacing with the computing hardware 215 for one or more vehicle control units 225. The vehicle control units 225 may be configured for controlling various functions of the vehicle 105. This may include, for example, a central exterior and interior controller (CEIC), a charging controller, or other controllers as further described herein.

The software layer 205 may be configured to provide software operations for executing various types of functionality and applications of the vehicle 105. FIG. 2C illustrates a diagram of the software layer 210 of the vehicle computing system 200. The architecture of the software layer 210 may be service oriented and may be configured to provide software for various functions of the vehicle computing system 200. To do so, the software layer 210 may include a plurality of sublayers 235A-E. For instance, the software layer 210 may include a first sublayer 235A including firmware (e.g., audio firmware) and a hypervisor, a second sublayer 235B including operating system components (e.g., open-source components), and a third sublayer 235C including middleware (e.g., for flexible integration with applications developed by an associated entity or third-party entity).

The vehicle computing system 200 may include an application layer 240. The application layer 240 may allow for integration with one or more software applications 245 that are downloadable or otherwise accessible by the vehicle 105. The application layer 240 may be configured, for example, using containerized applications developed by a variety of different entities.

The layered operating system and the vehicle's onboard computing resources may allow the vehicle computing system 200 to collect and communicate data as well as operate the systems implemented onboard the vehicle 105. FIG. 2D illustrates a block diagram of example systems and data of the vehicle 105.

The vehicle 105 may include one or more sensor systems 305. A sensor system may include or otherwise be in communication with a sensor of the vehicle 105 and a module for processing sensor data 310 associated with the sensor configured to acquire the sensor data 305. This may include sensor data 310 associated with the surrounding environment of the vehicle 105, sensor data associated with the interior of the vehicle 105, or sensor data associated with a particular vehicle function. The sensor data 310 may be indicative of conditions observed in the interior of the vehicle, exterior of the vehicle, or in the surrounding environment. For instance, the sensor data 305 may include image data, inside/outside temperature data, weather data, data indicative of a position of a user/object within the vehicle 105, weight data, motion/gesture data, audio data, or other types of data. The sensors may include one or more: cameras (e.g., visible spectrum cameras, infrared cameras), motion sensors, audio sensors (e.g., microphones), weight sensors (e.g., for a vehicle a seat), temperature sensors, humidity sensors, Light Detection and Ranging (LIDAR) systems, Radio Detection and Ranging (RADAR) systems, or other types of sensors. The sensors may also include sensors included with an autonomous drone. For instance, the vehicle 105 may accommodate an autonomous drone which includes additional sensors. The sensor data 310 captured by autonomous drone may augment the sensor data 310 of the vehicle. The vehicle 105 may include other sensors configured to acquire data associated with the vehicle 105. For example, the vehicle 105 may include inertial measurement units, wheel odometry devices, or other sensors.

The vehicle 105 may include a positioning system 315. The positioning system 315 may be configured to generate location data 320 (also referred to as position data) indicative of a location (also referred to as a position) of the vehicle 105. For example, the positioning system 315 may determine location by using one or more of inertial sensors (e.g., inertial measurement units, etc.), a satellite positioning system, based on IP address, by using triangulation and/or proximity to network access points or other network components (e.g., cellular towers, WiFi access points, etc.), or other suitable techniques. The positioning system 315 may determine a current location of the vehicle 105. The location may be expressed as a set of coordinates (e.g., latitude, longitude), an address, a semantic location (e.g., “at work”), etc.

In an embodiment, the positioning system 315 may be configured to localize the vehicle 105 within its environment. For example, the vehicle 105 may access map data that provides detailed information about the surrounding environment of the vehicle 105. The map data may provide information regarding: the identity and location of different roadways, road segments, buildings, or other items; the location and directions of traffic lanes (e.g., the location and direction of a parking lane, a turning lane, a bicycle lane, or other lanes within a particular roadway); traffic control data (e.g., the location, timing, or instructions of signage (e.g., stop signs, yield signs), traffic lights (e.g., stop lights), parking restrictions, or other traffic signals or control devices/markings (e.g., cross walks)); or any other data. The positioning system 315 may localize the vehicle 105 within the environment (e.g., across multiple axes) based on the map data. For example, the positioning system 155 may process certain sensor data 310 (e.g., LIDAR data, camera data, etc.) to match it to a map of the surrounding environment to get an understanding of the vehicle's position within that environment. The determined position of the vehicle 105 may be used by various systems of the vehicle computing system 200 or another computing system (e.g., the remote computing platform 110, the third-party computing platform 125, the user device 115).

The vehicle 105 may include a communications unit 325 configured to allow the vehicle 105 (and its vehicle computing system 200) to communicate with other computing devices. The vehicle computing system 200 may use the communications unit 325 to communicate with the remote computing platform 110 or one or more other remote computing devices over a network 130 (e.g., via one or more wireless signal connections). For example, the vehicle computing system 200 may utilize the communications unit 325 to receive platform data 330 from the computing platform 110. This may include, for example, an over-the-air (OTA) software update for the operating system of the vehicle computing system 200. Additionally, or alternatively, the vehicle computing system 200 may utilize the communications unit 325 to send vehicle data 335 to the computing platform 110. The vehicle data 335 may include any data acquired onboard the vehicle 105 including, for example, sensor data 310, location data 320, diagnostic data, user input data, data indicative of current software versions or currently running applications, occupancy data, data associated with the user 120 of the vehicle 105, or other types of data obtained (e.g., acquired, accessed, generated, downloaded, etc.) by the vehicle computing system 200.

In some implementations, the communications unit 325 may allow communication among one or more of the systems on-board the vehicle 105.

In an embodiment, the communications unit 325 may be configured to allow the vehicle 105 to communicate with or otherwise receive data from the user device 115 (shown in FIG. 1). The communications unit 325 may utilize various communication technologies such as, for example, Bluetooth low energy protocol, radio frequency signaling, or other short range or near filed communication technologies. The communications unit 325 may include any suitable components for interfacing with one or more networks, including, for example, transmitters, receivers, ports, controllers, antennas, or other suitable components that may help facilitate communication.

In an embodiment, the communications unit 325 may be configured to allow the vehicle to communicate with or otherwise receive data from an autonomous drone associated with the vehicle 105. For instance, the drone may be deploy to acquire additional sensor data 310 of the environment and communicate the sensor data 310 to the vehicle via the communications unit 325.

The vehicle 105 may include one or more human-machine interfaces (HMIs) 340. The human-machine interfaces 340 may include a display device, as described herein. The display device (e.g., touchscreen) may be viewable by a user of the vehicle 105 (e.g., user 120) that is located in the front of the vehicle 105 (e.g., driver's seat, front passenger seat). Additionally, or alternatively, a display device (e.g., rear unit) may be viewable by a user that is located in the rear of the vehicle 105 (e.g., back passenger seats). The human-machine interfaces 340 may present content 335 via a user interface for display to a user 120.

FIG. 3 illustrates an example vehicle interior 300 with a display device 345. The display device 345 may be a component of the vehicle's infotainment system. Such a component may be referred to as a display device of the infotainment system or be considered as a device for implementing an embodiment that includes the use of an infotainment system. For illustrative and example purposes, such a component may be referred to herein as a head unit display device (e.g., positioned in a front/dashboard area of the vehicle interior), a rear unit display device (e.g., positioned in the back passenger area of the vehicle interior), an infotainment head unit or rear unit, or the like. The display device 345 may be located on, form a portion of, or function as a dashboard of the vehicle 105. The display device 345 may include a display screen, CRT, LCD, plasma screen, touch screen, TV, projector, tablet, and/or other suitable display components.

The display device 345 may display a variety of content to the user 120 including information about the vehicle 105, prompts for user input, etc. The display device 345 may include a touchscreen through which the user 120 may provide user input to a user interface.

For example, the display device 345 may include user interface rendered via a touch screen that presents various content. The content may include vehicle speed, mileage, fuel level, charge range, navigation/routing information, audio selections, streaming content (e.g., video/image content), internet search results, comfort settings (e.g., temperature, humidity, seat position, seat massage), or other vehicle data 335. The display device 345 may render content to facilitate the receipt of user input. For instance, the user interface of the display device 345 may present one or more soft buttons with which a user 120 can interact to adjust various vehicle functions (e.g., navigation, audio/streaming content selection, temperature, seat position, seat massage, etc.). Additionally, or alternatively, the display device 345 may be associated with an audio input device (e.g., microphone) for receiving audio input from the user 120.

Returning to FIG. 2D, the vehicle 105 may include an emergency system 360. The emergency system 365 may be configured to obtain incident data 365. The incident data 365 may be indicative of an incident event including the vehicle 105. For example, the incident data 365 may include sensor data 310 from one or more sensors such as an airbag sensor, an impact sensor configured to detect an impact to the vehicle 105 by another object, a sensor configured to detect damaged vehicle components, a sensor configured to detect broken wired or wireless connections, etc. The incident event may include an accident, collision with an object (e.g., other vehicle, tree, guard rail), an unsafe vehicle maneuver (e.g., rollover, swerve offroad), etc. In some implementations, the emergency system 360 may be included in the communications system 325.

The vehicle 105 may include a plurality of vehicle functions 350A-C. A vehicle function 350A-C may be a functionality that the vehicle 105 is configured to perform based on a detected input. The vehicle functions 350A-C may include one or more: (i) vehicle comfort functions; (ii) vehicle staging functions; (iii) vehicle climate functions; (vi) vehicle navigation functions; (v) drive style functions; (v) vehicle parking functions; or (vi) vehicle entertainment functions. The user 120 may interact with a vehicle function 250A-C through user input (e.g., to an adjustable input device, UI element) that specifies a setting of the vehicle function 250A-C selected by the user.

Each vehicle function may include a controller 355A-C associated with that particular vehicle function 355A-C. The controller 355A-C for a particular vehicle function may include control circuitry configured to operate its associated vehicle function 355A-C. For example, a controller may include circuitry configured to turn the seat heating function on, to turn the seat heating function off, set a particular temperature or temperature level, etc.

In an embodiment, a controller 355A-C for a particular vehicle function may include or otherwise be associated with a sensor that captures data indicative of the vehicle function being turned on or off, a setting of the vehicle function, etc. For example, a sensor may be an audio sensor or a motion sensor. The audio sensor may be a microphone configured to capture audio input from the user 120. For example, the user 120 may provide a voice command to activate the radio function of the vehicle 105 and request a particular station. The motion sensor may be a visual sensor (e.g., camera), infrared, RADAR, etc. configured to capture a gesture input from the user 120. For example, the user 120 may provide a hand gesture motion to adjust a temperature function of the vehicle 105 to lower the temperature of the vehicle interior.

The controllers 355A-C may be configured to send signals to another onboard system. The signals may encode data associated with a respective vehicle function. The encoded data may indicate, for example, a function setting, timing, etc. In an example, such data may be used to generate content for presentation via the display device 345 (e.g., showing a current setting). In another examples, such data may be used to generate AR content for presentation via the user device 115 (e.g., AR glasses). Additionally, or alternatively, such data can be included in vehicle data 335 and transmitted to the remote computing platform 110.

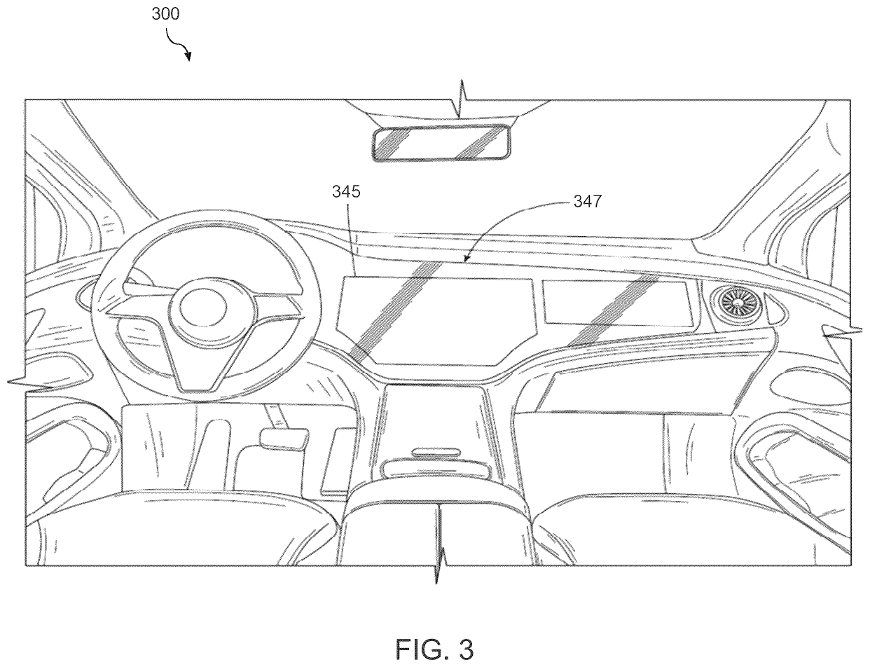

FIG. 4 illustrates a diagram of computing platform 110, which is remote from a vehicle according to an embodiment hereof. As described herein, the computing platform 110 may include a cloud-based computing platform.

In some implementations, the computing platform 110 may be implemented on a server, combination of servers, or a distributed set of computing devices which communicate over a network. For instance, the computing platform 110 may be distributed using one or more physical servers, private servers, or cloud computing. In some examples, the computing platform 110 may be implemented as a part of or in connection with one or more microservices, where, for example, an application is architected into independent services that communicate over APIs. Microservices may be deployed in a container (e.g., standalone software package for a software application) using a container service, or on VMs (virtual machines) within a shared network. Example, microservices may include a microservice associated with the vehicle software system 405, remote assistance system 415, etc. A container service may be a cloud service that allows developers to upload, organize, run, scale, manage, and stop containers using container-based virtualization to orchestrate the respective actions. A VM may include virtual computing resources which are not limited to a physical computing device. In some examples, the computing platform 110 may include or access one or more data stores for storing data associated with the one or more microservices. For instance, data stores may include distributed data stores, fully managed relational, NoSQL, and in-memory databases, etc.

The computing platform 110 may include a remote assistance system 415. The remote assistance system 415 may provide assistance to the vehicle 105. This can include providing information to the vehicle 105 to assist with charging (e.g., charging locations recommendations), remotely controlling the vehicle (e.g., for AV assistance), roadside assistance (e.g., for collisions, flat tires), etc. The remote assistance system 415 may obtain assistance data 420 to provide its core functions. The assistance data 420 may include information that may be helpful for the remote assistance system 415 to assist the vehicle 105. This may include information related to the vehicle's current state, an occupant's current state, the vehicle's location, the vehicle's route, charge/fuel level, incident data, etc. In some implementations, the assistance data 420 may include the vehicle data 335.

The remote assistance system 415 may transmit data or command signals to provide assistance to the vehicle 105. This may include providing data indicative of relevant charging locations, remote control commands to move the vehicle, connect to an emergency provider, etc.

The computing platform 110 may include a security system 425. The security system 425 can be associated with one or more security-related functions for accessing the computing platform 110 or the vehicle 105. For instance, the security system 425 can process security data 430 for identifying digital keys, data encryption, data decryption, etc. for accessing the services/systems of the computing platform 110. Additionally, or alternatively, the security system 425 can store security data 430 associated with the vehicle 105. A user 120 can request access to the vehicle 105 (e.g., via the user device 115). In the event the request includes a digital key for the vehicle 105 as indicated in the security data 430, the security system 425 can provide a signal to lock (or unlock) the vehicle 105.

The computing platform 110 may include a navigation system 435 that provides a back-end routing and navigation service for the vehicle 105. The navigation system 435 may provide map data 440 to the vehicle 105. The map data 440 may be utilized by the positioning system 315 of the vehicle 105 to determine a location of the vehicle 105, a point of interest, etc. The navigation system 435 may also provide routes to destinations requested by the vehicle 105 (e.g., via user input to the vehicle's head unit). The routes can be provided as a portion of the map data 440 or as separate routing data. Data provided by the navigation system 435 can be presented as content on the display device 345 of the vehicle 105. In some examples, data provided to the navigation system 435 can be presented as content on the user device 115 (e.g., AR glasses). For instance AR content may be presented to the user 120 via the user device 115.

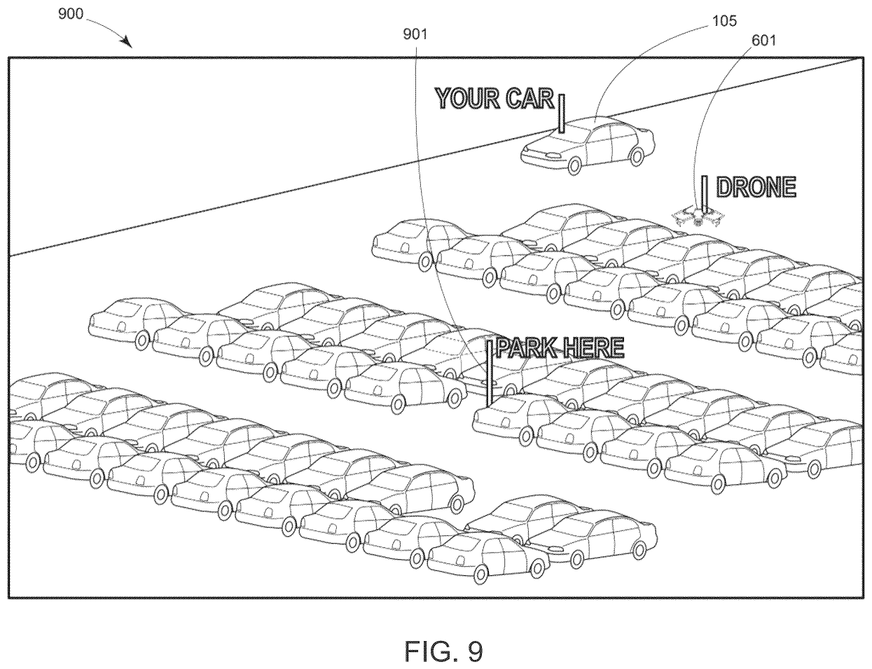

In an embodiment, the navigation system 435 may provide map data 440 to an autonomous drone associated with the vehicle 105. The drone may be an autonomous drone that includes an autonomy system onboard the drone. The autonomy system may include subsystems for autonomously operating the drone. This can a perception subsystem for processing sensor data and perceiving the drone's environment and a motion navigation system to plan and control the motion of the drone without human user input. The map data 440 may be utilized by the drone to determine a destination of the vehicle 105 and locate parking at the destination. The drone may be a point of interest and allow the vehicle to determine the location of the parking space by determining the location of the drone. An example of the vehicle 105 locating a drone is further described with reference to FIG. 9. Additionally, or alternatively, the drone can be controlled by a user that is remote from the drone.

In some implementations, the vehicle 105 may not have access to map data 440. For example, the vehicle 105 may be in an area with limited connectivity, cellular service, etc. The vehicle 105 may be able to navigate within its operating area based on one or more map tiles that were downloaded to the vehicle 105 prior to the vehicle 105 entering an area with limited connectivity. Additionally, or alternatively, the vehicle 105 may utilize image data capture from a drone to help with navigation. For instance, a drone may acquire image data of a parking lot and the vehicle 105. The drone, the vehicle 105, and/or another system may performing image processing techniques to determine a path through the parking lot. This may help the vehicle 105 navigate to a parking space, according to the technology of the present disclosure, without use of map data 440.

The computing platform 110 may include an entertainment system 445. The entertainment system 445 may access one or more databases for entertainment data 450 for a user 120 of the vehicle 105. In some implementations, the entertainment system 445 may access entertainment data 450 from another computing system associated with a third-party service provider of entertainment content. The entertainment data 450 may include media content such as music, videos, gaming data, etc. The entertainment data 450 may be provided to vehicle 105, which may output the entertainment data 450 as content 335 via one or more outputs devices of the vehicle 105 (e.g., display device, speaker, etc.).

The computing platform 110 may include a user system 455. The user system 455 may create, store, manage, or access user profile data 460. The user profile data 460 may include a plurality of user profiles, each associated with a respective user 120. A user profile may indicate various information about a respective user 120 including the user's preferences (e.g., for music, comfort settings, parking preferences), frequented/past destinations, past routes, etc. The user profiles may be stored in a secure database. In some implementations, when a user 120 enters the vehicle 120, the user's key (or user device) may provide a signal with a user or key identifier to the vehicle 105. The vehicle 105 may transmit data indicative of the identifier (e.g., via its communications system 325) to the computing platform 110. The computing platform 110 may look-up the user profile of the user 120 based on the identifier and transmit user profile data 460 to the vehicle computing system 200 of the vehicle 105. The vehicle computing system 200 may utilize the user profile data 460 to implement preferences of the user 120, present past destination locations, etc. The user profile data 460 may be updated based on information periodically provided by the vehicle 105. In some implementations, the user profile data 460 may be provided to the user device 120.

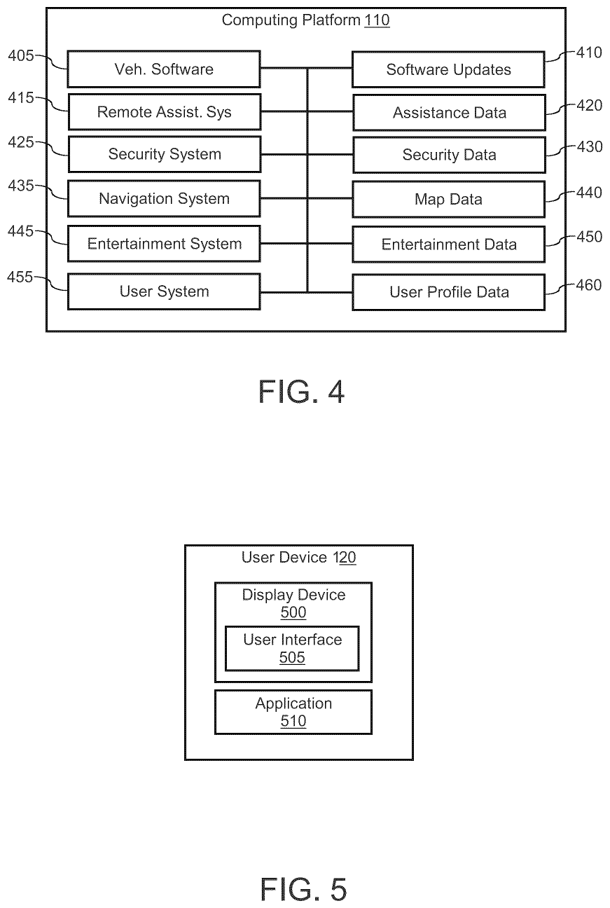

FIG. 5 illustrates a diagram of example components of user device 115 according to an embodiment hereof. The user device 115 may include a display device 500 configured to render content via a user interface 505 for presentation to a user 120. The display device 500 may include a display screen, AR glasses lens, CRT, LCD, plasma screen, touch screen, TV, projector, tablet, or other suitable display components. The user device 115 may include a software application 510 that is downloaded and runs on the user device 115. In some implementations, the software application 510 may be associated with the vehicle 105 or an entity associated with the vehicle 105 (e.g., manufacturer, retailer, maintenance provider). In an example, the software application 510 may enable the user device 115 to communicate with the computing platform 110 and the services thereof.

The user device 115 may be configured to pair with the vehicle 105 via a short-range wireless protocol. The short-range wireless protocol may include, for example, at least one of Bluetooth®, Wi-Fi, ZigBee, UWB, IR. The user device 115 may pair with the vehicle 105 through one or more known pairing techniques. For example, the user device 115 and the vehicle 105 may exchange information (e.g., addresses, device names, profiles) and store such information in their respective memories. Pairing may include an authentication process whereby the user 120 validates the connection between the user device 115 and the vehicle 105.

Once paired, the vehicle 105 and the user device 115 may exchange signals, data, etc. through the established communication channel. For example, the head unit 347 of the vehicle 105 may exchange signals with the user device 115.

The technology of the present disclosure allows the vehicle computing system 200 to extend its computing capabilities by leveraging the computing resources of the user device 115. More particularly, the vehicle computing system 200 may leverage the user device 115 to present navigational content to locate available parking spaces at a destination for the vehicle 105. As described herein, this technology can overcome potential inefficiencies introduced by locating available parking using the computing resources of the vehicle 105, while also extending the ability of the vehicle 105 to present navigational content.

The following describes the technology of the present disclosure within the context of example. For instance, example embodiments include pairing between a user device (e.g., wearable device) and a vehicle for facilitation of content presentation based on data from a drone. This example is meant for illustrative purposes and is not meant to be limiting. In some implementations, the user device (e.g., wearable device) may be in communication with a user device (e.g., a user's mobile phone through a pairing procedure). The user device may be connected to (e.g., paired with) the vehicle or another computing system (e.g., a cloud based platform, the drone). The user device can be serve as an intermediate to facilitate content generation in a manner similar to that described below for the vehicle computing system. Additionally, or alternatively, a remote computing system (e.g., cloud-based platform) can serve as such an intermediary.

FIG. 6 illustrates an example vehicle and drone operation according to an embodiment hereof. The example vehicle and drone operation 600 depicts a vehicle 105 and drone 601 navigating along a route 602 to a destination 604. In an embodiment, the vehicle 105 may deploy the drone 601 when the vehicle 105 reaches a deploy point 603 near the destination 604. Deploying the drone may include transmitting signals to cause the drone 601 to take off from the vehicle 105. For instance, the vehicle computing system 200 may communicate with the drone 601 to position the drone 601 in a take off position. In an embodiment, the vehicle computing system 200 may output one or more control signals to deploy (e.g., initiate a take-off flight path) the drone 601. In some examples, the drone 601 may autonomously deploy (e.g., take-off) based on determining the vehicle 105 has reached the deploy point 603. The vehicle may detect that it is at or near the deploy point based on a comparison of the vehicle's GPS data to an encoded map, localization of the vehicle within the vehicle's environment, etc.

The drone 601 may be affixed (e.g., docked) to a surface or portion of the exterior of the vehicle 105. For instance, the drone 601 may be docked on the roof of the vehicle 105. In an embodiment, the drone 601 may be docked on a docking unit on the exterior of the vehicle 105 such that the drone 601 is encapsulated within the vehicle 105 to prevent environmental damage (e.g., hail, rain, snow, etc.).

The drone 601 may include any type of aerial vehicle configured to operate within an environment. For example, the drone 601 may be an autonomous vehicle configured to autonomously perceive and operate within an environment. This can include multi-rotor drones, fixed-wing drones, single-rotor drones, or fixed-wing hybrid VTOL (e.g., vertical take-off landing) drones. The drone 601 may be an autonomous vehicle that can be controlled, be connected to, or be otherwise associated with the vehicle 105 for acquiring sensor data 310 of the environment.

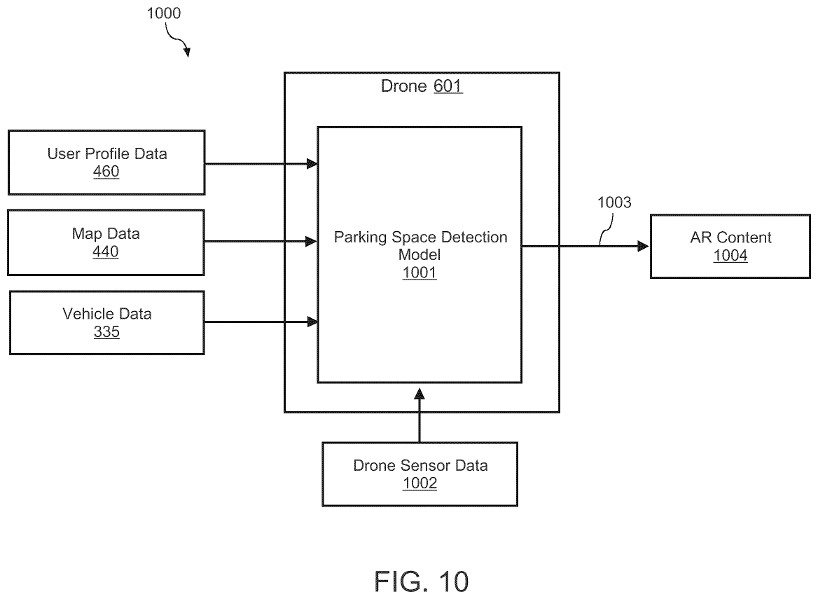

In an embodiment, the drone 601 may include one or more subsystems for performing various operations. For instance, the drone 601 may include a sensor suite, autonomy system, and control devices, etc. The sensor suite may include graphics processors, positioning sensors, optical sensors, etc., for perceiving the environment. The autonomy system may include a localization system, flight planning system, control system, etc., for autonomously operating the drone 601. The control system may include control devices for performing various flight control operations such as operating flight controllers, motors, propellers, etc. In another embodiment, the drone 601 may include one or more machine-learned models. An example drone 601 machine-learned model is further described with respect to FIG. 10. Certain routine and conventional components of drone 601 are not illustrated and/or discussed herein for the purpose of brevity. One of ordinary skill in the art will understand the operation of conventional drone components in drone 601.

The drone 601 may include a communication interface for communicating with the vehicle 105. The communication interface may include any circuits, components, software, etc. for communicating via one or more networks (e.g., network 130). In an embodiment, the drone 601 may be connected to the vehicle computing system 200 of the vehicle. For instance, the vehicle computing system 200 may use the communications unit 325 to communicate with the drone 601 over a network 130 (e.g., via one or more wireless signal connections).

In an embodiment, the drone 601 may communicate with the vehicle computing system 200 via near field or short range communication techniques (e.g., Bluetooth low energy protocol, radio frequency signaling, NFC protocol) when the drone 601 is docked on the vehicle 105. In another embodiment, the drone 601 may be communicatively coupled to the vehicle computing system 200. For instance, the drone 601 may transmit and receive data (e.g., map data 440, user profile data 460, sensor data 310, etc.) stored in the vehicle computing system 200 over a network 130 or near field or short field communication techniques. In some examples, the drone 601 may interact with subsystems (e.g., positioning system 315, sensor system 305, etc.) of the vehicle computing system 200.

In an embodiment, the vehicle 105 may access data indicative of the destination 604 of the vehicle 105. The destination 604 may be predetermined by a user 120 or determined by the navigation system 435 based on user input (e.g., via the display device 345, user device 115, etc.). For instance, the user 120 may provide user input indicating a desired destination 604. The vehicle computing system 200 may utilize one or more systems (e.g., navigation system 435) to generate the route 602 which indicates a path of travel to the destination 604. The vehicle 105 may access data indicative of the destination 604 based on the user input and route 602 the vehicle 105 is traveling.

In an embodiment, the vehicle 105 may determine the destination 604 is approaching a deploy point 603 to deploy the drone 601. For instance, the vehicle 105 may determine based on the destination 604 that parking will be required for the vehicle 105. For example, the vehicle computing system 200 may determine, based on map data 440, user profile data 460 (e.g., frequented/past destinations, past routes), etc., that the vehicle 105 may require parking at the destination 604. In an embodiment, the user 120 may indicate parking will be required at the destination 604 via user input. As the vehicle 105 is approaching or entering the destination 604, the vehicle 105 may determine a deploy point 603 near the destination 604 to survey the destination 604 for available parking spaces.

The deploy point 603 may be a relative location near the destination 604. For instance, the deploy point 603 may be a location less than a quarter of a mile from the destination 604. The deploy point 603 may be a location that is less than a threshold (e.g., a radial distance to a center of the parking area). In some examples, the deploy point 603 may be a location directly adjacent to the destination 603 (e.g., entry way of parking lot/garage).

In some examples, the deploy point 603 may be the nearest stationary location relative to the destination 604. For instance, the drone 601 may be unable to successfully deploy (e.g., take off) while the vehicle 105 is moving at a high rate of speed. As such, the drone 601 may require a deploy point 603 which includes a location where the vehicle 105 is stationary such as a stop sign, traffic light/intersection, etc. In an embodiment, the deploy point 603 may include a dynamic location. A dynamic location may include a radius or distance range deploy point 603 rather than a specific point. For instance, the drone 601 may be able to deploy (e.g., take off) while the vehicle 105 is moving at a lower rate of speed such that the drone 601 may deploy within a radius or distance range while the vehicle 105 is in motion.

The vehicle 105 may predetermine the deploy point 603 or dynamically determine the deploy point 603 while traveling along the route 602. For instance, the vehicle 105 may predetermine the deploy point 603 based on user profile data 460 indicating destination 604 as a frequented/past destination where a deploy point 603 have previously been determined. In some embodiments, the vehicle 105 may predetermine the deploy point 603 based on map data 440. In an embodiment, the vehicle 105 may travel along the route 602 and dynamically determine the deploy point 603 as the vehicle 105 is traveling to the destination. For instance, the vehicle 105 may determine its position includes a location within a threshold distance from the destination 603 and determine a suitable deploy point within the threshold distance. The threshold distance may be indicative of the capabilities of the drone 601 such as range or distance of the drone, battery or power resources, of the drone 601 etc. In some examples, the vehicle 105 may determine the deploy point 603 based on user input from a user 120. For instance, a vehicle operator may provide user input via the display device 345 to initiate the deployment of the drone 601.

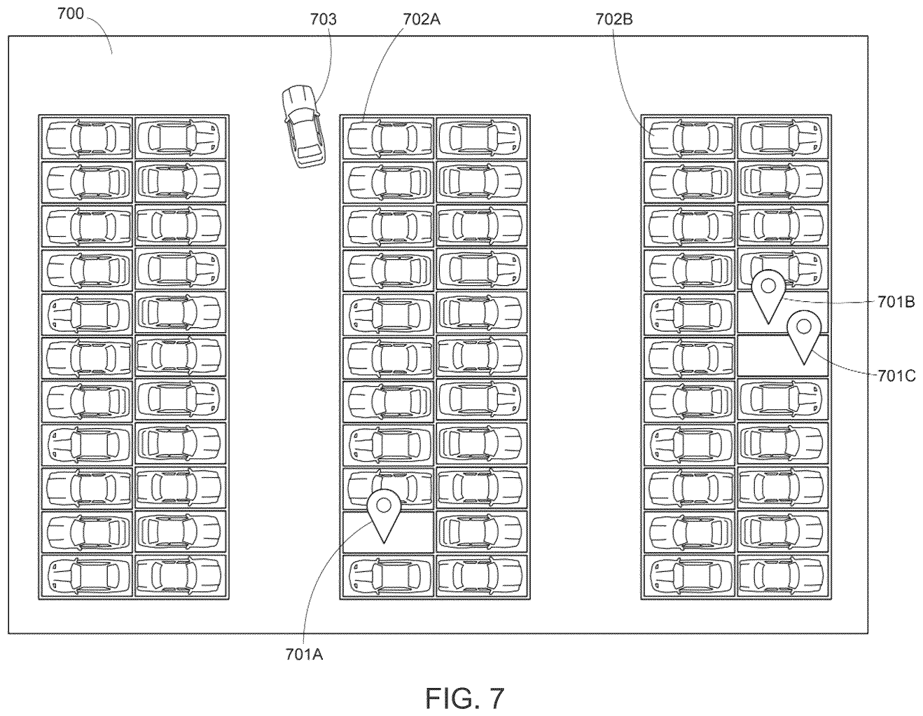

As the vehicle 105 reaches the deploy point 603, the vehicle 105 may deploy the drone 601 to survey the destination 604 to search for an available parking space for the vehicle 105. The destination 604 may include a parking lot, parking garage, suburban environment, or metropolitan environment. For instance, the destination 604 may include a shopping mall with an associated parking garage or parking lot. In some examples, the destination 604 may include restaurants, or other amenities in a downtown location. As such the drone 601 may survey the destination 601 in search of street parking (e.g., in a downtown location), garage parking, parking lot parking, or any type of parking area. An example parking area is further described with reference to FIG. 7.

In an embodiment, the drone 601 may be associated with a plurality of drones 601. For instance, the destination 604 may be associated with a plurality of drones 601. The plurality of drones 601 may be tasked with locating available parking spaces for incoming vehicles 105. By way of example, the vehicle computing system 200 may communicate with a remote parking area system associated with a destination such as a parking garage system, valet parking system etc. The parking area system may control a fleet of drones tasked with locating available parking spaces within the parking area. As the vehicle 105 approaches or enters the parking area, a drone 601 of the fleet of drones may be assigned to the vehicle 105. The drone 601 may locate an available parking space and communicate drone location data via the communication system 325 to the vehicle 105. This may include transmitting a communication to the remote parking area system, which can then provide such data to the vehicle 105.

FIG. 7 illustrates a parking area according to an embodiment hereof. The example parking area 700 includes an open parking lot with a plurality of unoccupied parking spaces 701A, 701B, 701C and occupied parking spaces 702A, 702B. The parking area 700 may also include vehicles traversing the parking area 700. For example, an exiting vehicle 703 may be indicative of an additional unoccupied parking space 701A, 701B, 701C.

The plurality of unoccupied parking spaces 701A, 701B, 701C and occupied parking spaces 702A, 702B may be dispersed across the parking area such that it may be difficult to locate unoccupied parking spaces 701A, 701B, 701C among a plurality of occupied parking spaces 702A, 702B. In an embodiment, the drone 601 may survey the parking area 700 by navigating to an aerial field of view of the parking area 700 as depicted in FIG. 7. For instance, an aerial field of view may provide clear visibility to all unoccupied parking spaces 701A, 701B, 701C and occupied parking spaces 702A, 702B. In an embodiment, the drone 601 may traverse each row of the parking area 700 to locate unoccupied parking spaces 701A, 701B, 701C. For instance, the parking area 700 may be a covered parking area, or parking garage. As such the drone 601 may not be able to obtain an unobscured aerial field of view of the parking area 700.

The drone 601 may search the parking area 700 (e.g., destination 604) and locate a plurality of unoccupied parking spaces 701A, 701B, 701C. In an embodiment, the drone 601 may determine a parking space of the plurality of unoccupied parking spaces 701A, 701B, 701C and provide location data indicating the location of the determined parking space. For instance, the drone 601 may determine a parking space of the plurality of unoccupied parking spaces 701A, 701B, 701C based on user preferences (e.g., user profile data 460). By way of example, the drone 601 may locate a plurality of unoccupied parking spaces 701A, 701B, 701C and compare the unoccupied parking spaces 701A. 701B. 701C to user preferences indicating a preferred distance from an entryway of the destination 604. The drone 601 may select unoccupied parking space 701A due to the proximity of the unoccupied parking space 701A to the entryway of the destination 604. In some examples, the drone 601 may determine that a parking space provides more clearance (e.g., for opening doors, exterior compartments, etc.) for the vehicle 105. For instance, unoccupied parking space 701B and 701C are adjacent to parking spaces. The drone 601 may select unoccupied parking space 701B or 701C rather than unoccupied parking space 701A due to more clearance space for the vehicle 105.

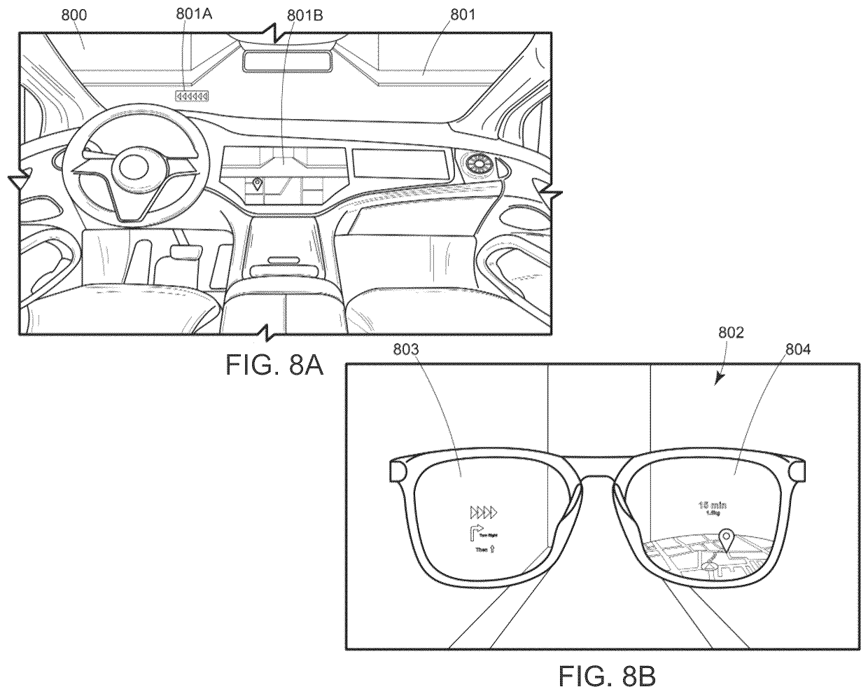

The drone 601 may determine a parking space of the plurality of unoccupied parking spaces 701A, 701B, 701C and navigate to the selected space to reserve the parking space. Reserving the parking space may include hovering above the parking space, landing within the parking space, outputting visual or audio indicators, or any means to indicate the parking space is occupied for other vehicles traversing the parking area 700. In some examples, the drone 601 may interact with a remote computing system (e.g., ticketing system, kiosk, etc.) associated with the parking area 700 to reserve the parking space. For instance, the drone 601 may obtain a ticket, transmit a reservation request, or reserve a parking space through a communication means. The drone 601 may transmit location data indicating the location of the parking space to the vehicle 105. For instance, the vehicle computing system 200 may receive drone location data from the drone 601 and generate content to present to the user 120 (e.g., vehicle operator) such that the vehicle 105 may navigate to the reserved parking space (e.g., location of the drone 601). An example of content presented to a vehicle operator is further described with reference to FIGS. 8A-8B.

In an embodiment, the drone 601 may unsuccessfully reserve the parking space. For instance, drone 601 may navigate to the selected space and another vehicle may ignore visual or audio indicators indicating the selected space is reserved. In some examples, the drone 601 may fail to communicate with a remote computing system associated with the parking area 700 to reserve a selected space prior to another vehicle occupying the selected space. In an embodiment, the drone 601 may search for another unoccupied parking space 701A, 701B, 701C. In some examples, the drone 601 may select a less preferred unoccupied parking space 701A, 701B, 701C. For instance, the drone 601 may select a space based on user preferences and disregard unoccupied parking spaces 701A, 701B, 701C. The drone 601 may determine that no unoccupied parking spaces 701A, 701B, 701C satisfy user preferences and select the space from the remaining unoccupied parking spaces 701A, 701B, 701C.

FIGS. 8A-B illustrates example user interfaces according to embodiments hereof. FIG. 8A depicts user interface 800. User interface 800 may include one or more user interface elements displayed across a field of view of a vehicle operator. For instance, user interface 800 may include a heads up interface element 801A, and display device user interface element 801B on a display device 345. In an embodiment, the heads up interface element 801A, and display device user interface element 801B may display content generated by the vehicle 105 (e.g., vehicle computing system 200). In some examples, the heads up interface element 801A, and display device user interface element 801B may display content generated by a user device 115. For instance, the user device 115 may be a head-worn user device (e.g., AR glasses).

In an embodiment, the user device 115 (e.g., AR glasses) may receive content generated from the vehicle computing system 200 and display the content via the user device 115. In some examples, the display of the user device 115 may include the field of view of the user 120 (e.g., vehicle operator) associated with the user device 115. By way of example, the user device 115 may include AR glasses which augments the field of view of the user 120 wearing the AR glasses. The vehicle computing system 200 may be connected to the AR glasses over one or more networks 130 or via near field or short range communication techniques. The vehicle computing system 200 may generate content indicative of the location of a reserved parking space (e.g., drone location) and display the content via the AR glasses.

For instance, a drone 601 may transmit location data indicating a location of an available parking spot. In some examples, the location of the available parking spot may be indicative of the location of the drone 601. The vehicle computing system 200 may receive the location data and generate, based on the location of the drone 601 and the location of the vehicle 105 a route to the location of the drone 601. The route may include one or more waypoints which indicates a path to the location of the drone 601. In some examples, the vehicle computing system 200 may output one or more signals to initiate a display of the content via the AR glasses.

The content may include navigational content (e.g., indicators indicating directions) which the vehicle operator may follow to lead to the location of the reserved parking space. For instance, interface element 801A may be an AR display rendered by AR glasses (e.g., smart glasses etc.) connected to the vehicle 105. In some examples, a portion of the interface element 801A may be rendered by the vehicle 105 and a portion may be rendered by the AR glasses. For instance, the vehicle 105 may include an infotainment head-unit including a display unit. The infotainment head-unit may display vehicle data 335 such as vehicle speed, cardinality, etc., while AR glasses display navigational indicators (e.g., generated content). In this way the element 801A may be an augmented infotainment head-unit via the AR glasses. In an embodiment, the heads up interface element 801A may be displayed only on the AR glasses. In another embodiment, the heads up interface element 801A may be displayed only on the infotainment head-unit.

In an embodiment, the AR glasses may receive content from the vehicle computing system 200 and augment the display device 345 component of the vehicle's infotainment system. For instance, the display device user interface element 801B may display content generated by the vehicle computing system 200 such as map data 440, sensor data 310, etc. The AR glasses may display the generated content including the navigational content (e.g., indicators indicating directions) such that the vehicle operator may follow the navigational content displayed by the AR glasses while utilizing data displayed via the display device 345. By way of example the display device 345 may display a current map of the environment of the vehicle 105. The AR glasses may display the content generated by the vehicle computing system 200 to augment the display of the current map to include directions to the location of the parking space reserved by the drone 601. In this way, the display device user interface element 801B may be an augmented display device 345 via the AR glasses.

In an embodiment, the AR glasses may augment any field of view of the vehicle operator. For instance, as depicted in FIG. 8B, the user interface 802 may include a left lens user interface element 803 and a right lens user interface element 804. The left lens user interface element 803 may display the content (e.g., navigational content) generated by the vehicle computing system 200 within any portion of the field of view of the vehicle operator. For instance, the left lens user interface element 803 may display a navigational indicator to make a right turn. In some examples, the left lens user interface element 803 may continue to display navigational indicators in a static or dynamic position within the left lens of the AR glasses of the field of view of the vehicle operator. By way of example, the vehicle operator may observe the left lens user interface element 803 in the left lens of the AR glass while looking in a forward direction. The left lens user interface element 803 may be positioned in the center of the left lens and maintain a center position as the vehicle operator begins looking in a left or right direction. In this way the left lens user interface element 803 displays the content generated by the vehicle computing system 200 consistently in the field of view of the vehicle operator. Additionally or alternatively, the left lens user interface element 804 may be positioned in the center, left, right, or any position within the left lens of the AR glasses.

The right lens user interface element 804 may display the content (e.g., navigational content) generated by the vehicle computing system 200 within any portion of the field of view of the vehicle operator. For instance, the right lens user interface element 804 may include a map of the surrounding environment of the vehicle operator positioned within the right lens of the AR glasses. The map may indicate the current position of the vehicle 105 and the distance from the location of the reserved parking spot. In an embodiment, the right lens user interface element 804 may be in a static or dynamic position within the right lens of the AR glasses of the field of view of the vehicle operator such that the right lens user interface element 804 is consistently in the field of view of the vehicle operator.

In an embodiment, the left lens user interface element 803 and the right lens user interface element 804 may be updated. For instance, as the vehicle 105 makes progress towards the location of the drone 601, the left lens user interface element 803 may be iteratively updated to display subsequent navigational indicator and the right lens user interface element 804 may be iteratively updated to display the updated distance from the reserved parking space. As the vehicle 105 approaches the location of the reserved parking space, the field of view of the vehicle operator may change such that the reserved parking space is within the field of view of the vehicle operator. In an embodiment, the AR glasses may display additional user interface elements to indicate the location of the reserved parking space. An example of a user interface indicating the location of the reserved parking space is further described with respect to FIG. 9.

FIG. 9 illustrates an example augmented user interface according to an embodiment hereof. The example drone operation 900 depicts a drone 601 providing locational indicators to a vehicle 105 indicating a reserved parking space 901, the drone 601 and the vehicle 105. For instance, the drone 601 may provide augmented sensor data to the vehicle computing system. The augmented sensor data may be utilized by the vehicle computing system 200 to generate content indicative of locational indicators. The content indicative of the locational indicators may be displayed on the user device 115 (e.g., AR glasses).

By way of example, the drone 601 may locate a plurality of unoccupied parking spaces 701A, 701B, 701C and determine a parking space for the vehicle 105. The drone 601 may determine the parking space for the vehicle 105 and generate a geotag associated with the determined parking space. A geotag may include geographical identification metadata which may be fused with sensor data 310. In some examples, the geotag may be an electronic tag associated with a set of coordinates, location on a map, etc. For instance, the drone 601 may include one or more camera sensors and generate a geospatial geotag for the selected parking space based on drone sensor data captured by the drone 601. In an embodiment, the drone 601 may transmit the geotag metadata indicating the determined parking space to the vehicle 105. The vehicle 105 may be configured to process the metadata in conjunction with map data to determine whether the parking space/drone is located within the environment. The vehicle 105 may generate content indicative of the reserved parking space 901 (e.g., the geotag) such that the user device 115 (e.g., AR glasses) may display the reserved parking space 901 location indicator (e.g., the geotag) within the field of view of the operator. Additionally or alternatively, the drone 601 may generate geotags for the drone 601 itself, the vehicle 601 or any other objects or locations within the field of view of the drone 601.

While the reserved parking space 901 location indicator displays text “PARK HERE” shown in FIG. 9, this is not intended to be limiting. The reserved parking space 901 location indicator may be any location indicator such a images, shapes, figures, or other AR projections which identify the reserved parking space 901.

FIG. 10 illustrates an example dataflow pipeline according to an embodiment hereof. The following description of dataflow in data pipeline 1000 is described with an example implementation in which the drone 601 utilizes a parking space detection model 1001 to process user profile data 460, map data 440, vehicle data 335, and drone sensor data 1002 to generate output 1003 indicative of a reserved parking space 901 within a parking area 700. Additionally, or alternatively, one or more portions of dataflow pipeline 1000 may be implemented within the vehicle computing system 200 of the vehicle 105.

The drone 601 may receive user profile data 460 indicating one or more user preferences of the user 120 (e.g., vehicle operator). User preferences may indicate one or more parking preferences of the vehicle operator. For instance, user preferences may include handicap parking, maximum parking distances from a destination (e.g., destination 604), maximum parking costs, assigned/designated parking or any other parking preferences. In an embodiment, the parking space detection model 1001 may determine user preferences based on user profile data 460. For instance, user profile data 460 may include previous/frequented destinations and indicate parking spaces selected by the vehicle operator. The parking space detection model 1001 may determine, based on previous parking habits, parking user preferences of the vehicle operator. In some examples, the vehicle computing system 200 may determine based on previous parking habits, parking user preferences. For instance, the vehicle computing system 200 may prompt the vehicle operator via the display device 345 to confirm parking user preferences based on parking habits. In some examples, the vehicle operator may input parking user preferences via the display device 345 to be stored as user profile data 460 within the user profile of the vehicle operator.

The drone 601 may receive map data 440 indicating a map of the environment including the destination 604. For instance, map data 440 may include the route 602 the vehicle 105 is traveling and the destination 604. The map data 440 may include parking areas 700 associated with the destination 604, parking area 700, etc. In an embodiment, the map data 440 may include restriction metadata. Restriction metadata may be indicative of a restriction associated with the available parking space. This may include any parking restrictions for parking spaces associated with the destination 604, such as reserved parking spaces, emergency vehicle designations, vehicle size restrictions (e.g., compact vehicles only), etc. By way of example, map data 440 may include a destination 604 located in a downtown metropolitan area subject to street parking restrictions during certain hours during the day. Parking subject to restrictions may be included as restriction metadata within map data 440 such that the drone 601 may not consider unoccupied parking spaces 701A, 701B, 701C associated with active parking restrictions. In an embodiment, the restriction metadata (e.g., restrictions) may be used to determine that unoccupied parking spaces 701A, 701B, 701C are appropriate for the vehicle 105.

The drone 601 may receive vehicle data 335 indicating location data 320 (e.g., the current location of the vehicle), and occupancy data (e.g., number of passengers, quantity of cargo etc.) for the vehicle 105. Vehicle data 335 may include, the deploy point 603 where the drone 601 was deployed. For instance, the vehicle computing system 200 may generate one or more control signals to deploy the drone 601 based on a determined deploy point 603 as the vehicle is approaching the destination 604. The determined deploy point 603 may be stored as vehicle data 335.

The drone 601 may obtain drone sensor data 1002 from one or more sensors of the drone 601. Drone sensor data 1002 may include a plurality of image frames depicting the parking area 700 associated with the destination. For instance, the image frames may depict an aerial view of the parking area 700. By way of example, the drone 601 may be deployed from the vehicle 105 and navigate to a parking area associated with the destination 604 to obtain drone sensor data 1002. The drone sensor data 1002 may include image frames depicting the entire parking area, occupied parking spaces 702A. 702B, unoccupied parking spaces 701A, 701B, 701C.

The drone 601 may include one or more machine-learned models that utilize the user profile data 460, map data 440, vehicle data 335, and drone sensor data 1002 to generate output 1003 indicative of an available parking space (e.g., unoccupied parking spaces 701A, 701B, 701C). For instance, the drone 601 may include a parking space detection model 1001.

In an embodiment, the parking space detection model 1001 may be an unsupervised or supervised learning model configured to detect and identify available parking spaces within a parking area 700. In some examples, the parking space detection model 1001 may include one or more machine-learned models. For example, the parking space detection model 1001 may include a machine-learned model trained to detect unoccupied parking spaces 701A, 701B. 701C. In some examples, the parking space detection model 1001 may include a machine-learned model trained to detect occupied parking spaces 702A, 702B. In other examples, the parking space detection model 1001 may include a machine-learned model trained to distinguish adjacent unoccupied parking spaces 701A, 701B, 701C by executing segmentation techniques.

The parking space detection model 1001 may be or may otherwise include various machine-learned models such as, for example, regression networks, generative adversarial networks, neural networks (e.g., deep neural networks), support vector machines, decision trees, ensemble models, k-nearest neighbors models, Bayesian networks, or other types of models including linear models or non-linear models. Example neural networks include feed-forward neural networks, recurrent neural networks (e.g., long short-term memory recurrent neural networks), convolutional neural networks, or other forms of neural networks.

The parking space detection model 1001 may be trained through the use of one or more model trainers and training data. The model trainers may be trained using one or more training or learning algorithms. One example training technique is backwards propagation of errors. In some examples, simulations may be implemented for obtaining the training data or for implementing the model trainer(s) for training or testing the model(s). In some examples, the model trainer(s) may perform supervised training techniques using labeled training data. As further described herein, the training data may include labelled image frames that have labels indicating an unoccupied parking space 701A, 701B, 701C. In some examples, the training data may include simulated training data (e.g., training data obtained from simulated scenarios, inputs, configurations, various parking areas, etc.).

Additionally, or alternatively, the model trainer(s) may perform unsupervised training techniques using unlabeled training data. By way of example, the model trainer(s) may train one or more components of a machine-learned model to perform parking space detection through unsupervised training techniques using an objective function (e.g., costs, rewards, heuristics, constraints, etc.). In some implementations, the model trainer(s) may perform a number of generalization techniques to improve the generalization capability of the model(s) being trained. Generalization techniques include weight decays, dropouts, or other techniques.

The parking space detection model 1001 may obtain drone sensor data 1002 indicative of a plurality of parking spaces within a parking area 700. The parking space detection model 1001 may be trained to detect unoccupied parking spaces 701A, 701B, 701C by performing segmentation techniques. Segmentation techniques may include analyzing the drone sensor data 1002 including one or more image frames and projecting a bounding shape on the image frames.

The bounding shape may be any shape (e.g., polygon) that includes one or more unoccupied parking spaces 701A, 701B, 701C. For instance, a bounding shape may include a shape that matches the outermost boundaries and contours of those boundaries for unoccupied parking spaces 701A. 701B, 701C. One of ordinary skill in the art will understand that other shapes may be used such as squares, circles, rectangles, etc. In some implementations, the bounding shape may be generated on a per pixel level. The space characteristics may include the x, y, z coordinates of the bounding shape center, the length, width, and height of the bounding shape, etc.

The parking space detection model 1001 may generate data (e.g., labels) that correspond to the parking space characteristics of the bounding shape. Labels may indicate the type of parking space (e.g., parallel parking space, perpendicular parking space, angular parking spaces, etc.), the size of the parking space, the orientation, etc.

The parking space detection model 1001 may execute segmentation techniques to distinguish adjacent parking spaces. For example, as depicted in FIG. 7, unoccupied parking spaces 701B and 701C are adjacent to each other. The drone senor data 1002 may include an image frame depicting both unoccupied parking spaces 701B and 701C. The parking space detection model 1001 may project a bounding shape that encapsulates the respective unoccupied parking spaces 701B. 701C and segment the image frame based on the unoccupied parking spaces 701B, 701C. The parking space detection model 1001 distinguish between the unoccupied parking spaces 701B, 701C and generate labels indicating the unoccupied parking spaces 701B, 701C as unique parking spaces.

The parking space detection model 1001 may identify a plurality of unoccupied parking spaces 701A, 701B, 701C and determine a reserved parking space 901 based on user profile data 460, map data 440, or vehicle data 335. For instance, the parking space detection model 1001 may identify a plurality of unoccupied parking spaces 701A, 701B, 701C and select unoccupied parking space 701A based on user profile data 460 and map data 440 indicating a maximum walking distance of user preference. The parking space detection model 1001 may determine, based on map data 440 that unoccupied parking space 701A is within the maximum walking distance of user preference and determine unoccupied parking space 701A as the reserved parking space 901.

By way of example, the parking space detection model 1001 may determine a reserved parking space 901 based on labels. For instance, the parking space detection model 1001 may determine that unoccupied parking space 701A is a compact parking space based on its size. The parking space detection model 1001 may generate a size label indicating the unoccupied parking space 701A is a small parking space. The parking space detection model 1001 may determine based on vehicle data 335 indicating the size of the vehicle that unoccupied parking space 701A is not large enough to accommodate the vehicle 105 and determine unoccupied parking spaces 701B or 701C based on the size label.

In another example, the parking space detection model 1001 may determine a reserved parking space 901 based on vehicle data 335. For instance, the drone 601 may obtain drone sensor data 1002 indicating that an exiting vehicle 703 vacated a previously occupied parking space. The parking space detection model 1001 may determine, based on vehicle data 335 indicating the location of the vehicle 105 is near the previously occupied parking space and determine the previously occupied parking space as the reserved parking space 901.

The parking space detection model 1001 may determine a reserved parking space 901 based on the orientation of the parking space. For instance, the vehicle operator (e.g., user 120) may indicate a user preference of avoiding parallel parking. The parking space detection model 1001 may determine a reserved parking space 901 based on the orientation (e.g., perpendicular) of the unoccupied parking spaces 701A, 701B, 701C.

The parking space detection model 1001 may output 1003 data indicative of the reserved parking space 901. In some examples, the output 1003 may be indicative of the location of the drone 601. For instance, the drone 601 may hover above or land in the reserved parking space 901. This may occur after the drone 601 has determined a suitable parking space for the vehicle 105. In some examples, the output 1003 may be indicative of one or more geotags. For instance, the drone 601 may generate a geotag indicating the location of the reserved parking space.

The output 1003 may be transmitted over one or more networks or via near field communication techniques to the vehicle computing system 200. The vehicle computing system 200 may utilize the output 1003 to generate AR content 1004. AR content may include computer generated content integrated into the real world. For instance, the vehicle computing system 200 may receive the output 1003 and utilize the location of the drone 601 and geotags to create digital content which may be displayed on the user device 115 (e.g., AR glasses). By way of example, the vehicle computing system 200 may receive output 1003 indicating the location of the drone 601 hovering above the reserved parking space 901. The vehicle computing system 200 may determine a route which leads to the location of the drone 601 and generate AR content which indicates content for navigating the location of the reserved parking space 901. The route may be based on map data. In an embodiment, the route may be determined based on image data acquired by the drone 601, which may show an aerial view of the parking area and the driving areas included therein.

The vehicle computing system 200 may generate AR content 1004 indicating navigational indicators and output one or more signals to initiate a display of the AR content via the user device 115 (e.g., AR glasses). The one or more signals may be communicated via one or more networks (e.g., network 130) or via near field communication techniques. The AR glasses may display the AR content and indicate a path with leads to the location of the reserved parking space (e.g., the location of the drone 601).

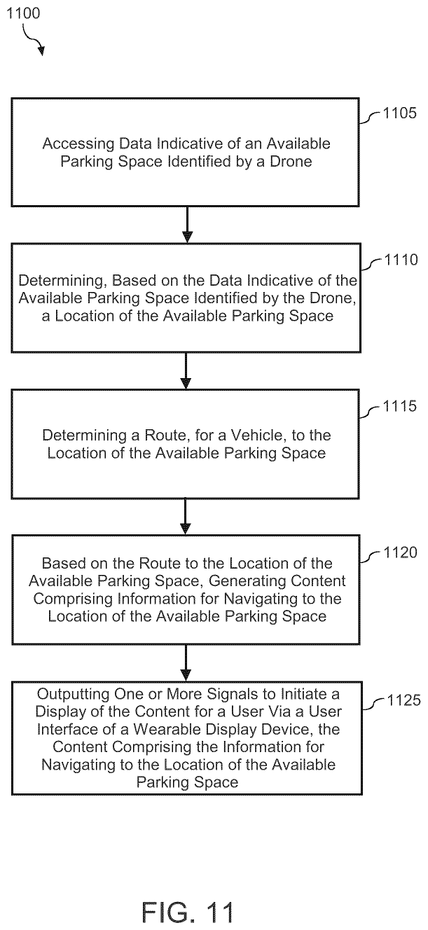

FIG. 11 illustrates a flowchart diagram of an example method 1100 for locating an available parking space according to an embodiment hereof. The method 1100 may be performed by a computing system described with reference to the other figures. In an embodiment, the method 1100 may be performed by the control circuit of a vehicle computing system 200 of FIG. 1. One or more portions of the method 1100 may be implemented as an algorithm on the hardware components of the devices described herein. For example, the steps of method 1100 may be implemented as operations/instructions that are executable by computing hardware.

FIG. 11 illustrates elements performed in a particular order for purposes of illustration and discussion. Those of ordinary skill in the art, using the disclosures provided herein, will understand that the elements of any of the methods discussed herein may be adapted, rearranged, expanded, omitted, combined, or modified in various ways without deviating from the scope of the present disclosure. FIG. 11 is described with reference to elements/terms described with respect to other systems and figures, for example illustrated purposes and is not meant to be limiting. One or more portions of method 1100 may be performed additionally, or alternatively, by other systems. For example, method 1100 may be performed by a control circuit of the remote computing platform 110 or of the drone 601.

In an embodiment, the method 1100 may begin with or otherwise include an operation 1105, in which the vehicle computing system 200 may access data indicative of an available parking space identified by a drone. For instance, the vehicle computing system 200 may access output 1003 generated by the parking space detection model 1001 of the drone 601. The output 1003 may be indicative of a reserved parking space 901 determined by the drone 601. In some example, the reserved parking space 901 may be associated with the location of the drone 601. For instance, the drone 601 may hover above or land in the reserved parking space 901 to prevent other vehicles from occupying the reserved parking space 901. In some examples, the reserved parking space 901 may be associated with a geotag indicating the location of the reserved parking space 901 within the parking area 700.

The method 1100 in an embodiment may include an operation 1110, in which the computing system 200 may determine, based on the data indicative of the available parking space identified by the drone, a location of the available parking space. For instance, the drone 601 may reserve the reserved parking space 901 by hovering above the parking space, landing within the parking space, or outputting audio/visual signals to indicate to other vehicles within the parking area 700 that the reserved parking space 901 is occupied. The drone 601 may transmit drone location data to the vehicle computing system 200. The drone location data may indicate the location of the reserved parking space 901.

The method 1100 in an embodiment may include an operation 1115, in which the computing system 200 may determine a route to the location of the available parking space. For instance, the navigation system 435 may receive the drone location data and utilize map data 440 to generate a route to the location of the drone. The route may include one or more waypoints or route segments which indicates a path from the current location of the vehicle 105 to the location of the drone 601 defined by the drone location data.

The method 1100 in an embodiment may include an operation 1115, in which the computing system 200 may generate content comprising information for navigating to the location of the available parking space. For instance, the controllers 355A-C may be configured to send signals across systems onboard the vehicle. The navigation system 435 may encode navigational data indicative of a route which leads to the reserved parking space 901. The encoded navigational content may include content for display on the user device 115 (e.g., AR glasses). For instance, the navigational content may include AR content for display on AR glasses (e.g., user device) of the vehicle operator.

The method 1100 in an embodiment may include an operation 1120, in which the computing system 200 may output one or more signals to initiate a display of the content for a user via a user interface of a wearable display device. The content may include the information for navigating to the location of the available parking space. For instance, the encoded navigational data may be transmitted over one or more networks 130 or via near field or short range communication techniques to the user device (e.g., AR glasses).

In some implementations the AR glasses may receive the navigational data and display the navigational content via the left or right lens of the AR glasses. For instance, navigational indicators may be displayed via a left lens user interface element 803 and a right lens user interface element 804. In some implementations, the AR glasses may display content which augments one or more displays of the infotainment system. For instance, the navigational indicators may be displayed via a heads up interface element 801A or a display device user interface element 801B on a display device 345. The vehicle operator may follow the navigational indicators to locate the reserved parking space 601 and the drone 601 may dock on the vehicle 105.

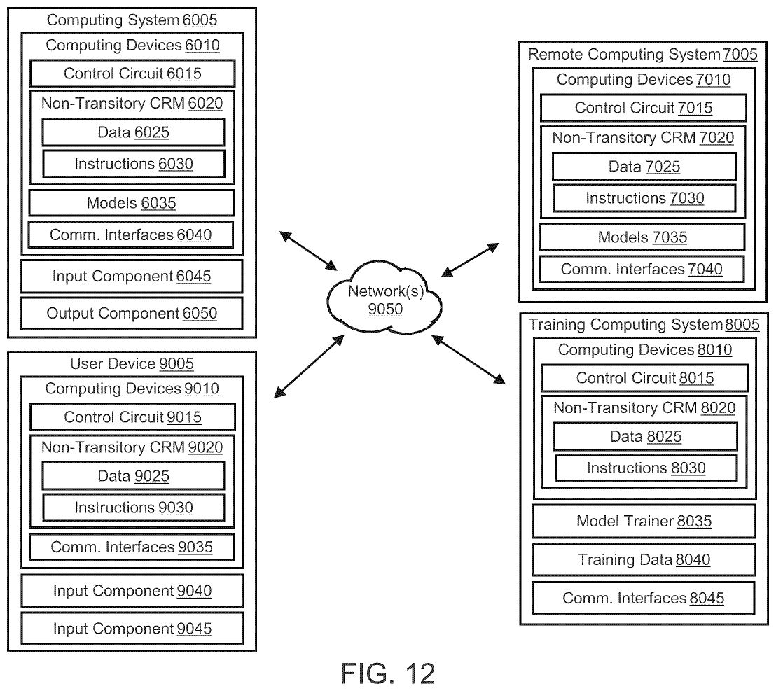

FIG. 12 illustrates a block diagram of an example computing system 1200 according to an embodiment hereof. The system 1200 includes a computing system 6005 (e.g., a computing system onboard a vehicle), a remote computing system 7005 (e.g., a drone computing system), a user device 9005 (e.g., a AR glasses), and a training computing system 8005 that are communicatively coupled over one or more networks 9050.

The computing system 6005 may include one or more computing devices 6010 or circuitry. For instance, the computing system 6005 may include a control circuit 6015 and a non-transitory computer-readable medium 6020, also referred to herein as memory. In an embodiment, the control circuit 6015 may include one or more processors (e.g., microprocessors), one or more processing cores, a programmable logic circuit (PLC) or a programmable logic/gate array (PLA/PGA), a field programmable gate array (FPGA), an application specific integrated circuit (ASIC), or any other control circuit. In some implementations, the control circuit 6015 may be part of, or may form, a vehicle control unit (also referred to as a vehicle controller) that is embedded or otherwise disposed in a vehicle (e.g., a Mercedes-Benz® car or van). For example, the vehicle controller may be or may include an infotainment system controller (e.g., an infotainment head-unit), a telematics control unit (TCU), an electronic control unit (ECU), a central powertrain controller (CPC), a charging controller, a central exterior & interior controller (CEIC), a zone controller, or any other controller. In an embodiment, the control circuit 6015 may be programmed by one or more computer-readable or computer-executable instructions stored on the non-transitory computer-readable medium 6020.

In an embodiment, the non-transitory computer-readable medium 6020 may be a memory device, also referred to as a data storage device, which may include an electronic storage device, a magnetic storage device, an optical storage device, an electromagnetic storage device, a semiconductor storage device, or any suitable combination thereof. The non-transitory computer-readable medium 6020 may form, e.g., a hard disk drive (HDD), a solid state drive (SDD) or solid state integrated memory, a random access memory (RAM), a read-only memory (ROM), an erasable programmable read-only memory (EPROM or Flash memory), a static random access memory (SRAM), dynamic random access memory (DRAM), a portable compact disc read-only memory (CD-ROM), a digital versatile disk (DVD), and/or a memory stick.

The non-transitory computer-readable medium 6020 may store information that may be accessed by the control circuit 6015. For instance, the non-transitory computer-readable medium 6020 (e.g., memory devices) may store data 6025 that may be obtained, received, accessed, written, manipulated, created, and/or stored. The data 6025 may include, for instance, any of the data or information described herein. In some implementations, the computing system 6005 may obtain data from one or more memories that are remote from the computing system 6005.

The non-transitory computer-readable medium 6020 may also store computer-readable instructions 6030 that may be executed by the control circuit 6015. The instructions 6030 may be software written in any suitable programming language or may be implemented in hardware. The instructions may include computer-readable instructions, computer-executable instructions, etc. As described herein, in various embodiments, the terms “computer-readable instructions” and “computer-executable instructions” are used to describe software instructions or computer code configured to carry out various tasks and operations. In various embodiments, if the computer-readable or computer-executable instructions form modules, the term “module” refers broadly to a collection of software instructions or code configured to cause the control circuit 6015 to perform one or more functional tasks. The modules and computer-readable/executable instructions may be described as performing various operations or tasks when the control circuit 6015 or other hardware component is executing the modules or computer-readable instructions.

The instructions 6030 may be executed in logically and/or virtually separate threads on the control circuit 6015. For example, the non-transitory computer-readable medium 6020 may store instructions 6030 that when executed by the control circuit 6015 cause the control circuit 6015 to perform any of the operations, methods and/or processes described herein. In some cases, the non-transitory computer-readable medium 6020 may store computer-executable instructions or computer-readable instructions, such as instructions to perform at least a portion of the method of FIG. 11.

In an embodiment, the computing system 6005 may store or include one or more machine-learned models 6035. For example, the machine-learned models 6035 may be or may otherwise include various machine-learned models, including machine-learned generative models (e.g., the parking space detection model 1001). In an embodiment, the machine-learned models 6035 may include neural networks (e.g., deep neural networks) or other types of machine-learned models, including non-linear models and/or linear models. Neural networks may include feed-forward neural networks, recurrent neural networks (e.g., long short-term memory recurrent neural networks), convolutional neural networks or other forms of neural networks. Some example machine-learned models may leverage an attention mechanism such as self-attention. For example, some example machine-learned models may include multi-headed self-attention models (e.g., transformer models). As another example, the machine-learned models 6035 can include generative models, such as stable diffusion models, generative adversarial networks (GAN), GPT models, and other suitable models.

In an aspect of the present disclosure, the models 6035 may be used to determine an available parking space in a parking area. For example, the machine-learned models 6035 can, in response to drone sensor data generate one or more labels indicating a parking space as occupied or unoccupied and indicating characteristics. The models 6035 may determine the identified parking space is unoccupied, meets any user preferences based on labels and determines a reserved parking space.

In an embodiment, the one or more machine-learned models 6035 may be received from the remote computing system 7005 over networks 9050, stored in the computing system 6005 (e.g., non-transitory computer-readable medium 6020), and then used or otherwise implemented by the control circuit 6015. In an embodiment, the computing system 6005 may implement multiple parallel instances of a single model.

Additionally, or alternatively, one or more machine-learned models 6035 may be included in or otherwise stored and implemented by the remote computing system 7005 that communicates with the computing system 6005 according to a client-server relationship. For example, the machine-learned models 6035 may be implemented by the remote computing system 7005 as a portion of a web service. Thus, one or more models 6035 may be stored and/or implemented (e.g., as models 7035) at the computing system 6005 and/or one or more models 6035 may be stored and implemented at the remote computing system 7005.

The computing system 6005 may include one or more communication interfaces 6040. The communication interfaces 6040 may be used to communicate with one or more other systems. The communication interfaces 6040 may include any circuits, components, software, etc. for communicating via one or more networks (e.g., networks 9050). In some implementations, the communication interfaces 6040 may include for example, one or more of a communications controller, receiver, transceiver, transmitter, port, conductors, software and/or hardware for communicating data/information.

The computing system 6005 may also include one or more user input components 6045 that receives user input. For example, the user input component 6045 may be a touch-sensitive component (e.g., a touch-sensitive display screen or a touch pad) that is sensitive to the touch of a user input object (e.g., a finger or a stylus). The touch-sensitive component may serve to implement a virtual keyboard. Other example user input components include a microphone, a traditional keyboard, cursor-device, joystick, or other devices by which a user may provide user input.

The computing system 6005 may include one or more output components 6050. The output components 6050 may include hardware and/or software for audibly or visually producing content. For instance, the output components 6050 may include one or more speakers, earpieces, headsets, handsets, etc. The output components 6050 may include a display device, which may include hardware for displaying a user interface and/or messages for a user. By way of example, the output component 6050 may include a display screen, CRT, LCD, plasma screen, touch screen, TV, projector, tablet, and/or other suitable display components.

The remote computing system 7005 may include one or more computing devices 7010. In an embodiment, the remote computing system 7005 may include or is otherwise implemented by one or more computing devices onboard an autonomous drone. In instances in which the remote computing system 7005 includes computing devices onboard an autonomous drone, such drone computing devices may operate according to sequential computing architectures, parallel computing architectures, or some combination thereof.

The remote computing system 7005 may include a control circuit 7015 and a non-transitory computer-readable medium 7020, also referred to herein as memory 7020. In an embodiment, the control circuit 7015 may include one or more processors (e.g., microprocessors), one or more processing cores, a programmable logic circuit (PLC) or a programmable logic/gate array (PLA/PGA), a field programmable gate array (FPGA), an application specific integrated circuit (ASIC), or any other control circuit. In an embodiment, the control circuit 7015 may be programmed by one or more computer-readable or computer-executable instructions stored on the non-transitory computer-readable medium 7020.

In an embodiment, the non-transitory computer-readable medium 7020 may be a memory device, also referred to as a data storage device, which may include an electronic storage device, a magnetic storage device, an optical storage device, an electromagnetic storage device, a semiconductor storage device, or any suitable combination thereof. The non-transitory computer-readable medium may form, e.g., a hard disk drive (HDD), a solid state drive (SDD) or solid state integrated memory, a random access memory (RAM), a read-only memory (ROM), an erasable programmable read-only memory (EPROM or Flash memory), a static random access memory (SRAM), dynamic random access memory (DRAM), a portable compact disc read-only memory (CD-ROM), a digital versatile disk (DVD), and/or a memory stick.

The non-transitory computer-readable medium 7020 may store information that may be accessed by the control circuit 7015. For instance, the non-transitory computer-readable medium 7020 (e.g., memory devices) may store data 7025 that may be obtained, received, accessed, written, manipulated, created, and/or stored. The data 7025 may include, for instance, any of the data or information described herein. In some implementations, the server system 7005 may obtain data from one or more memories that are remote from the server system 7005.

The non-transitory computer-readable medium 7020 may also store computer-readable instructions 7030 that may be executed by the control circuit 7015. The instructions 7030 may be software written in any suitable programming language or may be implemented in hardware. The instructions may include computer-readable instructions, computer-executable instructions, etc. As described herein, in various embodiments, the terms “computer-readable instructions” and “computer-executable instructions” are used to describe software instructions or computer code configured to carry out various tasks and operations. In various embodiments, if the computer-readable or computer-executable instructions form modules, the term “module” refers broadly to a collection of software instructions or code configured to cause the control circuit 7015 to perform one or more functional tasks. The modules and computer-readable/executable instructions may be described as performing various operations or tasks when the control circuit 7015 or other hardware component is executing the modules or computer-readable instructions.

The instructions 7030 may be executed in logically and/or virtually separate threads on the control circuit 7015. For example, the non-transitory computer-readable medium 7020 may store instructions 7030 that when executed by the control circuit 7015 cause the control circuit 7015 to perform any of the operations, methods and/or processes described herein. In some cases, the non-transitory computer-readable medium 7020 may store computer-executable instructions or computer-readable instructions, such as instructions to perform at least a portion of the method of FIG. 11.

The remote computing system 7005 may include one or more communication interfaces 7035. The communication interfaces 7035 may be used to communicate with one or more other systems. The communication interfaces 7035 may include any circuits, components, software, etc. for communicating via one or more networks (e.g., networks 7050). In some implementations, the communication interfaces 7035 may include for example, one or more of a communications controller, receiver, transceiver, transmitter, port, conductors, software and/or hardware for communicating data/information.

The computing system 6005 and/or the remote computing system 7005 may train the models 6035, 7035 via interaction with the training computing system 8005 that is communicatively coupled over the networks 9050. The training computing system 8005 may be separate from the remote computing system 7005 or may be a portion of the remote computing system 7005.

The training computing system 8005 may include one or more computing devices 8010. In an embodiment, the training computing system 8005 may include or is otherwise implemented by one or more server computing devices. In instances in which the training computing system 8005 includes plural server computing devices, such server computing devices may operate according to sequential computing architectures, parallel computing architectures, or some combination thereof.

The training computing system 8005 may include a control circuit 8015 and a non-transitory computer-readable medium 8020, also referred to herein as memory 8020. In an embodiment, the control circuit 8015 may include one or more processors (e.g., microprocessors), one or more processing cores, a programmable logic circuit (PLC) or a programmable logic/gate array (PLA/PGA), a field programmable gate array (FPGA), an application specific integrated circuit (ASIC), or any other control circuit. In an embodiment, the control circuit 8015 may be programmed by one or more computer-readable or computer-executable instructions stored on the non-transitory computer-readable medium 8020.

In an embodiment, the non-transitory computer-readable medium 8020 may be a memory device, also referred to as a data storage device, which may include an electronic storage device, a magnetic storage device, an optical storage device, an electromagnetic storage device, a semiconductor storage device, or any suitable combination thereof. The non-transitory computer-readable medium may form, e.g., a hard disk drive (HDD), a solid state drive (SDD) or solid state integrated memory, a random access memory (RAM), a read-only memory (ROM), an erasable programmable read-only memory (EPROM or Flash memory), a static random access memory (SRAM), dynamic random access memory (DRAM), a portable compact disc read-only memory (CD-ROM), a digital versatile disk (DVD), and/or a memory stick.

The non-transitory computer-readable medium 8020 may store information that may be accessed by the control circuit 8015. For instance, the non-transitory computer-readable medium 8020 (e.g., memory devices) may store data 8025 that may be obtained, received, accessed, written, manipulated, created, and/or stored. The data 8025 may include, for instance, any of the data or information described herein. In some implementations, the training computing system 8005 may obtain data from one or more memories that are remote from the training computing system 8005.

The non-transitory computer-readable medium 8020 may also store computer-readable instructions 8030 that may be executed by the control circuit 8015. The instructions 8030 may be software written in any suitable programming language or may be implemented in hardware. The instructions may include computer-readable instructions, computer-executable instructions, etc. As described herein, in various embodiments, the terms “computer-readable instructions” and “computer-executable instructions” are used to describe software instructions or computer code configured to carry out various tasks and operations. In various embodiments, if the computer-readable or computer-executable instructions form modules, the term “module” refers broadly to a collection of software instructions or code configured to cause the control circuit 8015 to perform one or more functional tasks. The modules and computer-readable/executable instructions may be described as performing various operations or tasks when the control circuit 8015 or other hardware component is executing the modules or computer-readable instructions.

The instructions 8030 may be executed in logically or virtually separate threads on the control circuit 8015. For example, the non-transitory computer-readable medium 8020 may store instructions 8030 that when executed by the control circuit 8015 cause the control circuit 8015 to perform any of the operations, methods and/or processes described herein. In some cases, the non-transitory computer-readable medium 8020 may store computer-executable instructions or computer-readable instructions, such as instructions to perform at least a portion of the methods of FIG. 11.

The training computing system 8005 may include a model trainer 8035 that trains the machine-learned models 6035, 7035 stored at the computing system 6005 and/or the remote computing system 7005 using various training or learning techniques. For example, the models 6035, 7035 (e.g., a parking space detection model) may be trained using a loss function that evaluates quality of generated samples over various characteristics, such as similarity to the training data.

The training computing system 8005 may modify parameters of the models 6035, 7035 (e.g., the parking space detection model 1001) based on the loss function (e.g., generative loss function) such that the models 6035, 7035 may be effectively trained for specific applications in a supervised manner using labeled data and/or in an unsupervised manner.

In an example, the model trainer 8035 may backpropagate the loss function through the machine-learned clustering model 320 to modify the parameters (e.g., weights) of the generative model (e.g., 620). The model trainer 8035 may continue to backpropagate the clustering loss function through the machine-learned model, with or without modification of the parameters (e.g., weights) of the model. For instance, the model trainer 8035 may perform a gradient descent technique in which parameters of the machine-learned model may be modified in a direction of a negative gradient of the clustering loss function. Thus, in an embodiment, the model trainer 8035 may modify parameters of the machine-learned model based on the loss function.

The model trainer 8035 may utilize training techniques, such as backwards propagation of errors. For example, a loss function may be backpropagated through a model to update one or more parameters of the models (e.g., based on a gradient of the loss function). Various loss functions may be used such as mean squared error, likelihood loss, cross entropy loss, hinge loss, and/or various other loss functions. Gradient descent techniques may be used to iteratively update the parameters over a number of training iterations.

In an embodiment, performing backwards propagation of errors may include performing truncated backpropagation through time. The model trainer 8035 may perform a number of generalization techniques (e.g., weight decays, dropouts, etc.) to improve the generalization capability of a model being trained. In particular, the model trainer 8035 may train the machine-learned models 6035, 7035 based on a set of training data 8040.

The training data 8040 may include unlabeled training data for training in an unsupervised fashion. Furthermore, in some implementations, the training data 8040 can include labeled training data for training in a supervised fashion. For example, the training data 8040 can be or can include the training data 610 of FIG. 6A.

In an embodiment, if the user has provided consent/authorization, training examples may be provided by the computing system 6005 (e.g., of the user's vehicle). Thus, in such implementations, a model 6035 provided to the computing system 6005 may be trained by the training computing system 8005 in a manner to personalize the model 6035.

The model trainer 8035 may include computer logic utilized to provide desired functionality. The model trainer 8035 may be implemented in hardware, firmware, and/or software controlling a general-purpose processor. For example, in an embodiment, the model trainer 8035 may include program files stored on a storage device, loaded into a memory and executed by one or more processors. In other implementations, the model trainer 8035 may include one or more sets of computer-executable instructions that are stored in a tangible computer-readable storage medium such as RAM, hard disk, or optical or magnetic media.

The training computing system 8005 may include one or more communication interfaces 8045. The communication interfaces 8045 may be used to communicate with one or more other systems. The communication interfaces 8045 may include any circuits, components, software, etc. for communicating via one or more networks (e.g., networks 9050). In some implementations, the communication interfaces 8045 may include for example, one or more of a communications controller, receiver, transceiver, transmitter, port, conductors, software and/or hardware for communicating data/information.

The computing system 6005, the remote computing system 7005, and/or the training computing system 8005 may also be in communication with a user device 9005 that is communicatively coupled over the networks 9050.

The user device 9005 may include various types of user devices. This may include wearable devices (e.g., glasses, watches, etc.), handheld devices, tablets, or other types of devices.

The user device 9005 may include one or more computing devices 9010. The user device 9005 may include a control circuit 9015 and a non-transitory computer-readable medium 9020, also referred to herein as memory 9020. In an embodiment, the control circuit 9015 may include one or more processors (e.g., microprocessors), one or more processing cores, a programmable logic circuit (PLC) or a programmable logic/gate array (PLA/PGA), a field programmable gate array (FPGA), an application specific integrated circuit (ASIC), or any other control circuit. In an embodiment, the control circuit 9015 may be programmed by one or more computer-readable or computer-executable instructions stored on the non-transitory computer-readable medium 9020.

In an embodiment, the non-transitory computer-readable medium 9020 may be a memory device, also referred to as a data storage device, which may include an electronic storage device, a magnetic storage device, an optical storage device, an electromagnetic storage device, a semiconductor storage device, or any suitable combination thereof. The non-transitory computer-readable medium may form, e.g., a hard disk drive (HDD), a solid state drive (SDD) or solid state integrated memory, a random access memory (RAM), a read-only memory (ROM), an erasable programmable read-only memory (EPROM or Flash memory), a static random access memory (SRAM), dynamic random access memory (DRAM), a portable compact disc read-only memory (CD-ROM), a digital versatile disk (DVD), and/or a memory stick.

The non-transitory computer-readable medium 9020 may store information that may be accessed by the control circuit 9015. For instance, the non-transitory computer-readable medium 9020 (e.g., memory devices) may store data 9025 that may be obtained, received, accessed, written, manipulated, created, and/or stored. The data 9025 may include, for instance, any of the data or information described herein. In some implementations, the user device 9005 may obtain data from one or more memories that are remote from the user device 9005.

The non-transitory computer-readable medium 9020 may also store computer-readable instructions 9030 that may be executed by the control circuit 9015. The instructions 9030 may be software written in any suitable programming language or may be implemented in hardware. The instructions may include computer-readable instructions, computer-executable instructions, etc. As described herein, in various embodiments, the terms “computer-readable instructions” and “computer-executable instructions” are used to describe software instructions or computer code configured to carry out various tasks and operations. In various embodiments, if the computer-readable or computer-executable instructions form modules, the term “module” refers broadly to a collection of software instructions or code configured to cause the control circuit 9015 to perform one or more functional tasks. The modules and computer-readable/executable instructions may be described as performing various operations or tasks when the control circuit 9015 or other hardware component is executing the modules or computer-readable instructions.

The instructions 9030 may be executed in logically or virtually separate threads on the control circuit 9015. For example, the non-transitory computer-readable medium 9020 may store instructions 9030 that when executed by the control circuit 9015 cause the control circuit 9015 to perform any of the operations, methods and/or processes described herein. In some cases, the non-transitory computer-readable medium 9020 may store computer-executable instructions or computer-readable instructions, such as instructions to perform at least a portion of the method of FIG. 11.

The user device 9005 may include one or more communication interfaces 9035. The communication interfaces 9035 may be used to communicate with one or more other systems. The communication interfaces 9035 may include any circuits, components, software, etc. for communicating via one or more networks (e.g., networks 7050). In some implementations, the communication interfaces 9035 may include for example, one or more of a communications controller, receiver, transceiver, transmitter, port, conductors, software and/or hardware for communicating data/information.

The user device 9005 may also include one or more user input components 9040 that receives user input. For example, the user input component 9040 may be a touch-sensitive component (e.g., a touch-sensitive display screen or a touch pad) that is sensitive to the touch of a user input object (e.g., a finger or a stylus). The touch-sensitive component may serve to implement a virtual keyboard. Other example user input components include a microphone, a traditional keyboard, cursor-device, joystick, or other devices by which a user may provide user input.

The user device 9005 may include one or more output components 9045. The output components 9045 may include hardware and/or software for audibly or visually producing content. For instance, the output components 9045 may include one or more speakers, earpieces, headsets, handsets, etc. The output components 9045 may include a display device, which may include hardware for displaying a user interface and/or messages for a user. By way of example, the output component 9045 may include a display screen, CRT, LCD, plasma screen, touch screen, TV, projector, tablet, and/or other suitable display components. As described herein, the output components 9045 may include a form factor such as lens of glasses. This can be used for an AR interface displayed via the user device 9005, while it is worn by a user.

The one or more networks 9050 may be any type of communications network, such as a local area network (e.g., intranet), wide area network (e.g., Internet), or some combination thereof and may include any number of wired or wireless links. In general, communication over a network 9050 may be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

### Additional Discussion of Various Embodiments

Embodiment 1 relates to a computing system of a vehicle. The computing system may include a control circuit. The control circuit may be configured to access data indicative of an available parking space identified by a drone. The control circuit may be configured to determine, based on the data indicative of the available parking space identified by the drone, a location of the available parking space. The control circuit may be configured to determine a route, for a vehicle, to the location of the available parking space. The control circuit may be configured to, based on the route to the location of the available parking space, generate content including information for navigating to the location of the available parking space. The control circuit may be configured to output one or more signals to initiate a display of the content for a user via a user interface of a wearable display device, the content including the information for navigating to the location of the available parking space.

Embodiment 2 includes the computing system of Embodiment 1. In this embodiment, the control circuit may be configured to determine that the vehicle is approaching, or has entered, a parking area. In this embodiment, the control circuit may be configured to output one or more signals to initiate the drone to take-off from onboard the vehicle to search the parking area for one or more available parking spaces.

Embodiment 3 includes the computing system of any of embodiments 1 or 2. In this embodiment, the content includes augmented reality content including a user interface element, the user interface element indicating the location of the available parking space.

Embodiment 4 includes the computing system of any of embodiments 1 to 3. In this embodiment, the wearable display device is a head-worn computing device, and wherein the user interface element indicating the location of the available parking space is visible in a field-of-view that includes the available parking space.

Embodiment 5 includes the computing system of any of embodiments 1 to 4. In this embodiment, the data indicative of the available parking space identified by the drone includes location data provided by the drone.

Embodiment 6 includes the computing system of any of embodiments 1 to 5. In this embodiment, the location data is indicative of a location of the drone.

Embodiment 7 includes the computing system of Embodiment 6. In this embodiment, to determine the location of the available parking space, the control circuit is configured to determine the location of the available parking space based on the location of the drone.

Embodiment 8 includes the computing system of Embodiment 6. In this embodiment, to determine the route, for the vehicle, to the location of the available parking space the control circuit is configured to determine a route to the location of the drone.

Embodiment 9 includes the computing system of any of embodiments 1 to 8. In this embodiment, the drone is positioned above the available parking space.

Embodiment 10 includes the computing system of any of embodiments 1 to 9. In this embodiment, the control circuit is configured to access map data associated with a parking area comprising the available space. In this embodiment, to determine the route, for the vehicle, to the location of the available parking space, the control circuit is configured to determine the route based also on the map data associated with the parking area.

Embodiment 11 includes the computing system of any of embodiments 1 to 10. In this embodiment, the drone is included within a plurality of drones associated with the parking area.

Embodiment 12 includes the computing system of any of embodiments 1 to 11. In this embodiment, the user input is indicative of a physics event associated with the vehicle and the presentation of the data indicative of the generated content via the display device positioned on the wheel is based on the physics event.

Embodiment 13 relates to a computer-implemented method. The method can include accessing data indicative of an available parking space identified by a drone. The method can include determining, based on the data indicative of the available parking space identified by the drone, a location of the available parking space. The method can include determining a route, for a vehicle, to the location of the available parking space. The method can include based on the route to the location of the available parking space, generating content including information for navigating to the location of the available parking space. The method can include outputting one or more signals to initiate a display of the content for a user via a user interface of a wearable display device, the content including the information for navigating to the location of the available parking space.

Embodiment 14 includes the method of embodiment 13. In this embodiment, the method can include determining that the vehicle is approaching, or has entered, a parking area. In this embodiment, the method can include outputting one or more signals to initiate the drone to take-off from onboard the vehicle to search the parking area for one or more available parking spaces.

Embodiment 15 includes the method of embodiment 13 to 14. In this embodiment, the content includes augmented reality content including a user interface element, the user interface element indicating the location of the available parking space.

Embodiment 16 includes the method of embodiment 13 to 15. In this embodiment, the wearable display device is a head-worn computing device. In this embodiment, the user interface element indicating the location of the available parking space is visible in a field-of-view that includes the available parking space.

Embodiment 17 includes the method of any of embodiments 13 or 16. In this embodiment, the data indicative of the available parking space identified by the drone includes location data provided by the drone.

Embodiment 18 includes the method of embodiment 17. In this embodiment, the location data is indicative of a location of the drone.

Embodiment 19 includes the method of embodiment 17. In this embodiment, determining the location of the available parking space, includes determining the location of the available parking space based on the location of the drone.

Embodiment 20 is directed to one or more non-transitory computer-readable media. The one or more non-transitory computer readable media can store instructions that are executable by a control circuit. The control circuit executing the instructions can access data indicative of an available parking space identified by a drone. The control circuit executing the instructions can determine, based on the data indicative of the available parking space identified by the drone, a location of the available parking space. The control circuit executing the instructions can determine a route, for a vehicle, to the location of the available parking space. The control circuit executing the instructions can, based on the route to the location of the available parking space, generating content including information for navigating to the location of the available parking space. The control circuit executing the instructions can output one or more signals to initiate a display of the content for a user via a user interface of a wearable display device, the content including the information for navigating to the location of the available parking space.

### Additional Disclosure

As used herein, adjectives and their possessive forms are intended to be used interchangeably unless apparent otherwise from the context and/or expressly indicated. For instance, “component of a/the vehicle” may be used interchangeably with “vehicle component” where appropriate. Similarly, words, phrases, and other disclosure herein is intended to cover obvious variants and synonyms even if such variants and synonyms are not explicitly listed.

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein may be implemented using a single device or component or multiple devices or components working in combination. Databases and applications may be implemented on a single system or distributed across multiple systems. Distributed components may operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, may readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment may be used with another embodiment to yield a still further embodiment. Thus, it is intended that the present disclosure cover such alterations, variations, and equivalents.

Aspects of the disclosure have been described in terms of illustrative implementations thereof. Numerous other implementations, modifications, or variations within the scope and spirit of the appended claims may occur to persons of ordinary skill in the art from a review of this disclosure. Any and all features in the following claims may be combined or rearranged in any way possible. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but,” etc. It should be understood that such conjunctions are provided for explanatory purposes only. The term “or” and “and/or” may be used interchangeably herein. Lists joined by a particular conjunction such as “or,” for example, may refer to “at least one of” or “any combination of” example elements listed therein, with “or” being understood as “and/or” unless otherwise indicated. Also, terms such as “based on” should be understood as “based at least in part on.”

Those of ordinary skill in the art, using the disclosures provided herein, will understand that the elements of any of the claims, operations, or processes discussed herein may be adapted, rearranged, expanded, omitted, combined, or modified in various ways without deviating from the scope of the present disclosure. At times, elements may be listed in the specification or claims using a letter reference for exemplary illustrated purposes and is not meant to be limiting. Letter references, if used, do not imply a particular order of operations or a particular importance of the listed elements. For instance, letter identifiers such as (a), (b), (c), . . . , (i), (ii), (iii), . . . , etc. may be used to illustrate operations or different elements in a list. Such identifiers are provided for the ease of the reader and do not denote a particular order, importance, or priority of steps, operations, or elements. For instance, an operation illustrated by a list identifier of (a), (i), etc. may be performed before, after, or in parallel with another operation illustrated by a list identifier of (b), (ii), etc.

What is claimed is:

1. A computing system comprising:
a control circuit configured to:
access data indicative of an available parking space identified by a drone;
determine, based on the data indicative of the available parking space identified by the drone, a location of the available parking space;
determine a route, for a vehicle, to the location of the available parking space;
based on the route to the location of the available parking space, generate content comprising information for navigating to the location of the available parking space; and
output one or more signals to initiate a display of the content for a user via a user interface of a wearable display device, the content comprising the information for navigating to the location of the available parking space.

2. The computing system of claim 1, wherein control circuit is configured to:
determine that the vehicle is approaching, or has entered, a parking area; and
output one or more signals to initiate the drone to take-off from onboard the vehicle to search the parking area for one or more available parking spaces.

3. The computing system of claim 1, wherein the content comprises augmented reality content including a user interface element, the user interface element indicating the location of the available parking space.

4. The computing system of claim 1, wherein the wearable display device is a head-worn computing device, and wherein the user interface element indicating the location of the available parking space is visible in a field-of-view that comprises the available parking space.

5. The computing system of claim 1, wherein the data indicative of the available parking space identified by the drone comprises location data provided by the drone.

6. The computing system of claim 5, wherein the location data is indicative of a location of the drone.

7. The computing system of claim 6, wherein to determine the location of the available parking space, the control circuit is configured to determine the location of the available parking space based on the location of the drone.

8. The computing system of claim 6, wherein to determine the route, for the vehicle, to the location of the available parking space the control circuit is configured to determine a route to the location of the drone.

9. The computing system of claim 1, wherein the drone is positioned above the available parking space.

10. The computing system of claim 1, wherein the control circuit is further configured to:
access map data associated with a parking area comprising the available space; and
wherein to determine the route, for the vehicle, to the location of the available parking space, the control circuit is configured to determine the route based also on the map data associated with the parking area.

11. The computing system of claim 1, wherein the drone is included within a plurality of drones associated with the parking area.

12. The computing system of claim 1, wherein the control circuit is configured to:
determine that the available parking space is appropriate for the vehicle based on at least one of: (i) a type of the available parking space; (ii) a size of the available parking space; (iii) an orientation of the available parking space; (iv) a restriction associated with the available parking space; or (v) a preference of the user.

13. A computer-implemented method comprising:
accessing data indicative of an available parking space identified by a drone;
determining, based on the data indicative of the available parking space identified by the drone, a location of the available parking space;
determining a route, for a vehicle, to the location of the available parking space;
based on the route to the location of the available parking space, generating content comprising information for navigating to the location of the available parking space; and
outputting one or more signals to initiate a display of the content for a user via a user interface of a wearable display device, the content comprising the information for navigating to the location of the available parking space.

14. The computer-implemented method of claim 13, further comprising:
determining that the vehicle is approaching, or has entered, a parking area; and
outputting one or more signals to initiate the drone to take-off from onboard the vehicle to search the parking area for one or more available parking spaces.

15. The computer-implemented method of claim 13, wherein the content comprises augmented reality content including a user interface element, the user interface element indicating the location of the available parking space.

16. The computer-implemented method of claim 13, wherein the wearable display device is a head-worn computing device, and wherein the user interface element indicating the location of the available parking space is visible in a field-of-view that comprises the available parking space.

17. The computer-implemented method of claim 13, wherein the data indicative of the available parking space identified by the drone comprises location data provided by the drone.

18. The computer-implemented method of claim 17, wherein the location data is indicative of a location of the drone.

19. The computer-implemented method of claim 17, wherein determining the location of the available parking space, comprises determining the location of the available parking space based on the location of the drone.

20. One or more non-transitory computer-readable media that store instructions that are executable by a control circuit to:
access data indicative of an available parking space identified by a drone;
determine, based on the data indicative of the available parking space identified by the drone, a location of the available parking space;
determine a route, for a vehicle, to the location of the available parking space;
based on the route to the location of the available parking space, generating content comprising information for navigating to the location of the available parking space; and
output one or more signals to initiate a display of the content for a user via a user interface of a wearable display device, the content comprising the information for navigating to the location of the available parking space.
